(19) United States
(12) Patent Application Publication
(10) Pub. No.: US 2011/0285756 A1
(43) Pub. Date: Nov. 24, 2011

(54) ELECTROPHORETIC DISPLAY DEVICE, DRIVING METHOD THEREFOR, AND ELECTRONIC APPARATUS

(75) Inventor: Takashi SATO, Chino (JP)

(73) Assignee: SEIKO EPSON CORPORATION, Tokyo (JP)

(21) Appl. No.: 13/107,142

(22) Filed: May 13, 2011

(30) Foreign Application Priority Data
May 20, 2010 (JP) 2010-116412
Mar. 15, 2011 (JP) 2011-056718

(51) Int. Cl. G09G 3/34; G02F 1/167; G09G 5/10

(52) U.S. Cl. 345/690; 359/296; 345/107

(57) ABSTRACT

An electrophoretic display device includes a first substrate and a second substrate, an electrophoretic layer disposed between the first substrate and the second substrate and containing at least a dispersion medium and positively or negatively charged particles mixed in the dispersion medium, first electrodes formed in island shapes and driven independently in respective pixels on a side of the electrophoretic layer of the first substrate, a second electrode formed on a side of the electrophoretic layer of the second substrate and having a larger area than the first electrodes, transistors connected to the first electrodes, and a first control electrode disposed in at least part of an area where the first electrodes are absent above a drain electrode of a first transistor of the transistors. A potential for repelling the particles is applied to the first control electrode.

### BACKGROUND

1. Technical Field

The present invention relates to electrophoretic display devices and driving methods therefor, and electronic apparatuses.

2. Related Art

In recent years, the use of electrophoretic display devices as display sections of electronic paper and the like has been spreading. An electrophoretic display device includes an electrophoretic dispersion liquid in which a plurality of electrophoretic particles are dispersed in a liquid phase dispersion medium (a dispersion medium). For the purpose of performing display, the electrophoretic display device utilizes the fact that application of an electric field causes the distribution state of electrophoretic particles to vary, and, as a result, the optical characteristics of the electrophoretic dispersion liquid vary.

For such an electrophoretic display device, there has been proposed a concept of a color electrophoretic display device using three types of particles as disclosed in JP-A-2009-9092, JP-A-2007-98382, and JP-A-2003-186065. JP-A-2009-9092, JP-A-2007-98382, and JP-A-2003-186065 disclose that three types of particles, that is, positively charged particles, negatively charged particles, and uncharged particles are driven using three electrodes.

In the proposals disclosed in JP-A-2009-9092, JP-A-2007-98382, and JP-A-2003-186065, however, there are problems in terms of controllability of brightness and saturation in one subpixel for implementing a color electrophoretic display device, and therefore it is difficult to perform full color display. There has been no proposal of a method of controlling three or at least one of brightness, saturation, and hue in an analog fashion in a color electrophoretic display device.

### SUMMARY

An advantage of some aspects of the invention is that it provides an electrophoretic display device and an electronic apparatus that control the movement of electrophoretic particles to be able to control three or at least one of the brightness, saturation, and hue, so that excellent color display can be performed.

Another advantage of some aspects of the invention is that it provides an electrophoretic display device, a driving method therefor, and an electronic apparatus that control the movement of electrophoretic particles to be able to control three or at least one of the brightness, saturation, and hue, so that excellent color display can be performed.

An aspect of the invention provides an electrophoretic display device including a first substrate and a second substrate, an electrophoretic layer disposed between the first substrate and the second substrate and containing at least a dispersion medium and positively or negatively charged particles mixed in the dispersion medium, first electrodes formed in island shapes and driven independently in respective pixels on a side of the electrophoretic layer of the first substrate, a second electrode formed on a side of the electrophoretic layer of the second substrate and having a larger area than the first electrodes, transistors connected to the first electrodes; and a first control electrode disposed in at least part of an area where the first electrodes are absent above a drain electrode of a first transistor of the transistors. A potential for repelling the particles is applied to the first control electrode.

According to this aspect, in a portion above the drain electrode of the first transistor where the first electrodes are absent, the first control electrode is disposed in at least part of an area where the first electrodes are absent, and a potential for repelling particles that are charged either positively or negatively is applied to the first control electrode, which makes it possible to control a potential in the area where the first control electrode is provided and where the first electrodes are absent. This can prevent the positively or negatively charged particles from being retained in the area, thus leading to stable display.

It is preferable that the potential for repelling the particles be the same potential as a potential of the second electrode, the same potential as a potential of the first electrodes, or a potential between the potential of the first electrodes and the potential of the second electrode.

According to this aspect, the potential for repelling the particles is the same potential as a potential of the second electrode, the same potential as a potential of the first electrodes, or a potential between the potential of the first electrodes and the potential of the second electrode, and thus the particles on the first control electrode can be repelled efficiently.

It is also preferable that the first control electrode be disposed between a layer in which the first electrodes are formed and a layer in which the drain electrode of the first transistor is formed.

If the first control electrode is formed in the same layer as the first electrodes, there is worry that a short-circuit between the first control electrode and the first electrodes would be made. According to this aspect, however, the first control electrode is disposed in a layer different from that of the first electrodes, and therefore a short-circuit defect can be prevented.

It is also preferable that the first control electrode be formed in the same layer as the layer in which the first electrodes are formed.

According to this aspect, the first control electrode and the first electrodes are formed in the same layer, and therefore both these electrodes can be formed using the same material in the same process. This enables the first control electrode to be manufactured with ease without adding a new process of forming the first control electrode.

It is also preferable that the first control electrode be provided with openings at positions facing the first electrodes, the openings having areas larger than areas of the first electrodes.

According to this aspect, the first control electrode can be disposed around the first electrodes in plan view. Even in cases where the first control electrode and the first electrodes are formed in the same layer, electrical insulation between the first control electrode and the first electrodes is secured. Accordingly, a short-circuit defect can be prevented.

It is also preferable that the openings have shapes similar to shapes in plan view of the first electrodes.

According to this aspect, it becomes possible to cover more drain electrodes with the first control electrode while securing electrical insulation between the first control electrode and the first electrodes. Shielding over the drain electrodes is provided by the first control electrode, and therefore a data voltage can be prevented from being applied directly to an electrophoretic material to affect display. Thus, excellent display can be obtained in a stable manner.

It is also preferable that a plurality of the first electrodes be connected to one another with a first connecting electrode formed in a layer closer to the first substrate than the first electrodes.

According to this aspect, the plurality of the first electrodes are connected to one another with the first connecting electrode formed in the layer closer to the first substrate than the first electrode, and therefore the same voltage can be collectively applied to the plurality of the first electrodes, which facilitates control.

It is also preferable that the electrophoretic display device further include third electrodes and a second transistor of the transistors. The third electrodes are formed in the respective pixels on the side of the electrophoretic layer of the first substrate and driven independently of the first electrodes. The second transistor is connected to the third electrodes.

According to this aspect, different voltages are applied to the first electrodes and the third electrodes, which makes it possible to control the two-dimensional or three-dimensional distributions on the second electrode of particles that are charged at polarities different from each other and particles that are charged either positively or negatively.

It is also preferable that a second control electrode be disposed in at least part of an area where the third electrodes are absent above a drain electrode of the second transistor.

According to this aspect, the second control electrode is disposed in at least part of the area where the third electrodes are absent above the drain electrode of the second transistor, and therefore the first control electrode and the second control electrode can be driven independently of each other. This makes it possible to cause two particles to move at the same time in one frame.

It is also preferable that a plurality of the first electrodes be connected to one another with a first connecting electrode formed in a layer closer to the first substrate than the first electrodes, and a plurality of the third electrodes be connected to one another with a second connecting electrode formed in a layer closer to the first substrate than the third electrodes.

According to this aspect, the same potential can be applied at the same time to the plurality of the first electrodes or the plurality of the third electrodes, which facilitates control.

It is also preferable that the electrophoretic display device further include a first scanning line, a second scanning line, a first data line, and a second data line; the first transistor connected to the first scanning line and the first data line and the second transistor connected to the second scanning line and the second data line be disposed in each of the pixels; the first control electrode be formed in a layer different from the drain electrode of the first transistor; and the second control electrode be formed in a layer different from the drain electrode of the second transistor.

According to this aspect, shielding over the drain electrodes of the transistors can be provided by the first control electrode and the second control electrode, and therefore a data voltage is prevented from being applied directly to the electrophoretic layer to affect display. Thus, excellent display is obtained in a stable manner.

It is also preferable that a first particle of the particles and a second particle of the particles be mixed in the dispersion medium, the first particle being positively charged, and the second particle being negatively charged and differing in color from the first particle.

According to this aspect, combining the color of the dispersion medium and the color of particles enables full color display.

Another aspect of the invention provides a method of driving an electrophoretic display device that includes a first substrate and a second substrate, an electrophoretic layer disposed between the first substrate and the second substrate and containing at least a dispersion medium and positively or negatively charged particles mixed in the dispersion medium, first electrodes formed in island shapes and driven independently in respective pixels on a side of the electrophoretic layer of the first substrate, a second electrode formed on a side of the electrophoretic layer of the second substrate and having a larger area than the first electrodes, and transistors connected to the first electrodes. In the electrophoretic display device, a first control electrode is disposed in at least part of an area where the first electrodes are absent above a drain electrode of a first transistor of the transistors, and a gray scale is controlled by using an area of the particles visually recognized when the electrophoretic layer is viewed from a side of the second electrode. The method includes performing a first operation of drawing the particles to a side of the first electrodes for the first electrodes and the second electrode, and performing a second operation of drawing the particles to the side of the second electrode for the first electrodes and the second electrode. In the first operation and the second operation, a potential for repelling the charged particles is preferably applied to the first control electrode.

According to this aspect, at the time of moving particles that are charged either positively or negatively, a potential for repelling the charged particles is applied to the first control electrode, which can cause the particles to smoothly move to the side of the first electrodes or the side of the second electrode. It is therefore possible to prevent the particles from being retained on the first substrate.

It is preferable that the first control electrode be caused to have the same potential as a potential of the second electrode, the same potential as a potential of the first electrodes, or a potential between the potential of the first electrodes and the potential of the second electrode.

According to this aspect, the first control electrode be caused to have the same potential as a potential of the second electrode, the same potential as a potential of the first electrodes, or a potential between the potential of the first electrodes and the potential of the second electrode, which can prevent the particles from flying to the side of the first control electrode. Thus, the particles that are charged either positively or negatively can be efficiently repelled from the first control electrode.

It is also preferable that a two-dimensional or three-dimensional distribution of the charged particles on the side of the second substrate be controlled by using magnitudes and durations of voltages to be applied to the first electrodes and the second electrode.

According to this aspect, the two-dimensional or three-dimensional distribution of the particles on the side of the second substrate (the second electrode) is controlled by using magnitudes and durations of voltages to be applied to the electrodes, which enables gray-scale control. Thus, display of an arbitrary color can be realized.

It is also preferable that the durations be controlled by using a pulse width or a number of frames.

According to this aspect, the durations are controlled by using the pulse width or the number of frames, which enables gray-scale control to be performed with ease. Thus, display of an arbitrary color can be realized with reliability.

It is also preferable that the electrophoretic display device include third electrodes on the side of the electrophoretic layer of the first substrate, and voltages different from each other be simultaneously applied to the first electrodes and the third electrodes.

According to this aspect, the two-dimensional or three-dimensional distributions on the second electrode of particles that are charged at polarities different from each other and particles that are charged either positively or negatively can be controlled at the same time.

It is also preferable that the electrophoretic display device include third electrodes on the side of the electrophoretic layer of the first substrate, and voltages different from each other be sequentially applied to the first electrodes and the third electrodes.

According to this aspect, the two-dimensional or three-dimensional distributions on the second electrode of particles that are charged at polarities different from each other and particles that are charged either positively or negatively can be sequentially controlled.

It is also preferable that the electrophoretic display device include third electrodes on the side of the electrophoretic layer of the first substrate, and that the method further include performing first pre-set operation of applying to the first electrodes a voltage of positive polarity with respect to the second electrode and applying to the third electrodes a voltage of negative polarity with respect to the second electrode, thereby drawing the particles to the side of the first electrodes and to a side of the third electrodes, and performing second pre-set operation of applying to the first electrodes a voltage of negative polarity with respect to the second electrode and applying to the third electrodes a voltage of positive polarity with respect to the second electrode, thereby drawing the particles to the side of the first electrodes and to the side of the third electrodes.

According to this aspect, with the polarities of voltages to be applied to the first electrodes and the third electrodes changed between the first pre-set operation and the second pre-set operation, display is performed. This eliminates DC (Direct Current) components among the first electrodes, the second electrode, and the third electrodes, and, as a result, the first electrodes, the second electrode, and the third electrodes are alternately driven. This can prevent the deterioration of the electrophoretic material, the corrosion of electrodes, and the like.

It is also preferable that the first pre-set operation and the second pre-set operation be alternately performed.

According to this aspect, the first pre-set operation and the second pre-set operation are alternately performed, which allows display to be performed after the state is once returned to the initial state by the pre-set operation. Thus, the movement of particles is smoother than when display operation is continuously performed. Display shifting can be performed in a stable manner.

It is also preferable that the electrophoretic display device include a second transistor of the transistors, the second transistor being connected to the third electrodes, and the second control electrode driven independently of the first control electrode be disposed in at least part of an area where the third electrodes are absent above a drain electrode of the second transistor.

According to this aspect, shielding above the drain electrode of the second transistor can be provided. This prevents a data voltage from being applied directly to the electrophoretic layer. Thus, display problems are prevented.

It is also preferable that the particles of a first color be negatively charged, and the particles of a second color be positively charged.

According to this aspect, voltages of different polarities are applied to the first control electrode and the second control electrode, which can control the movement of the first color particles and the movement of the second color particles, respectively.

A further aspect of the invention provides an electronic apparatus including the electrophoretic display device of an embodiment of the invention.

According to this aspect, a display section that can perform smooth movement of particles and thus can perform color display in a stable manner is included. Therefore, at least any of the brightness, saturation, and hue of a displayed image can be controlled as appropriate.

### BRIEF DESCRIPTION OF THE DRAWINGS

The invention will be described with reference to the accompanying drawings, wherein like numbers reference like elements.

FIG. 1A is a plan view illustrating an overall configuration of an electrophoretic display device according to a first embodiment, and FIG. 1B is an equivalent circuit diagram illustrating the overall configuration of the electrophoretic display device.

FIG. 2 is a partial sectional view illustrating a pixel structure of the electrophoretic display device.

FIGS. 3A through 3D are explanatory illustrations illustrating distribution states of particles during driving in the electrophoretic display device.

FIGS. 4A and 4B are explanatory illustrations illustrating distribution states of particles at a pre-set time in the electrophoretic display device.

FIG. 5 is an equivalent circuit diagram illustrating a specific configuration example in the first embodiment.

FIG. 6 is a plan view illustrating a specific structure example of one pixel on the element substrate side of the first embodiment.

FIG. 7 is a sectional view taken along the line VII-VII of FIG. 6.

FIG. 8 is a partial sectional view illustrating a pixel structure of the electrophoretic display device.

FIG. 9 is a partial sectional view illustrating a schematic structure of an existing electrophoretic display device.

FIG. 10 is a partial sectional view illustrating a schematic structure of the electrophoretic display device of the first embodiment.

FIGS. 11A and 11B are explanatory illustrations illustrating a driving method in the electrophoretic display device of the first embodiment.

FIGS. 12A and 12B are explanatory illustrations illustrating the driving method in the electrophoretic display device of the first embodiment.

FIGS. 13A through 13C are partial sectional views for illustrating manufacturing processes for the electrophoretic display device of the first embodiment.

FIGS. 14A through 14C are partial sectional views for illustrating the manufacturing processes for the electrophoretic display device of the first embodiment.

FIG. 15 is a partial sectional view for illustrating the manufacturing processes for the electrophoretic display device of the first embodiment.

FIGS. 16A and 16B are plan views illustrating modifications of a control electrode.

FIGS. 17A and 17B are plan views illustrating modifications of the control electrode.

FIG. 18 is a plan view illustrating a pixel structure of an electrophoretic display device of a second embodiment.

FIG. 19 is a plan view illustrating a modification of control electrodes of the second embodiment.

FIG. 20 is a partial sectional view illustrating a schematic structure of an electrophoretic display device of a third embodiment.

FIG. 21 is a plan view illustrating a modification of pixel electrodes.

FIG. 22 is a plan view illustrating a modification of pixel electrodes.

FIGS. 23A through 23C are sectional views illustrating other examples of an electrophoretic layer.

FIGS. 24A through 24C are sectional views illustrating other examples of the electrophoretic layer.

FIG. 25 is a sectional view illustrating another example of the electrophoretic layer (one-particle system).

FIGS. 26A and 26B illustrate a modification of a pixel electrode.

FIGS. 27A and 27B illustrate a modification of the pixel electrode.

FIG. 28 illustrates a modification of pixel electrodes.

FIGS. 29A through 29C illustrate exemplary electronic apparatuses.

FIG. 30 illustrates a distribution state of charged particles during voltage application.

FIGS. 31A and 31B illustrate distribution states of charged particles during voltage application.

FIG. 32 is a sectional view illustrating a modification of a layout in one pixel.

### DESCRIPTION OF EXEMPLARY EMBODIMENTS

Embodiments of the invention will be described below with reference to the accompanying drawings. It is to be noted that each element will be appropriately scaled to a recognizable size in the drawings to be referred to in the following description. Herein, red is referred to also as R, and cyan, magenta, and yellow are referred to also as C, M, and Y, respectively.

### First Embodiment

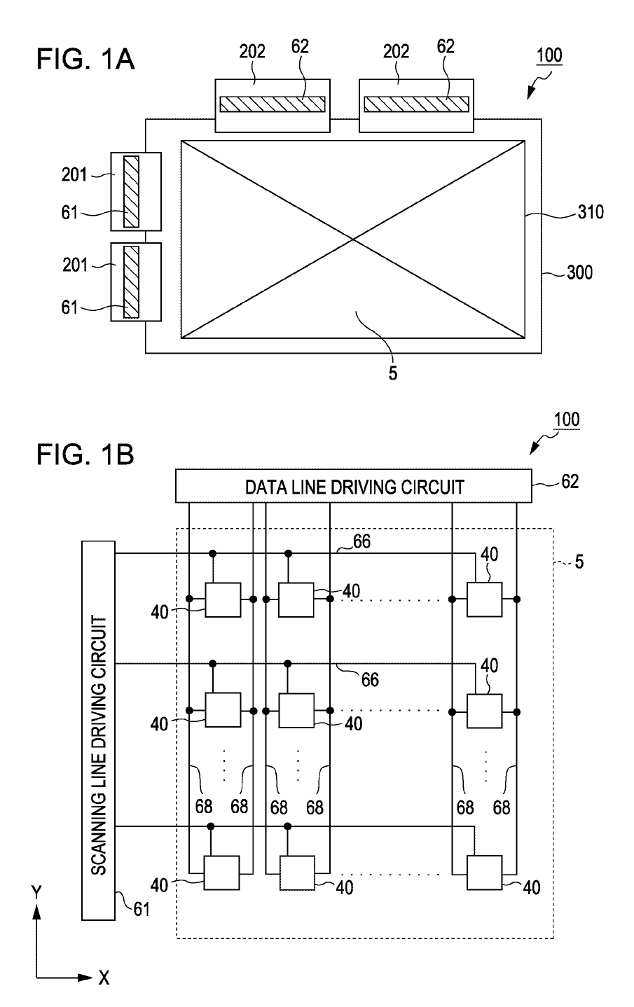

FIG. 1A is a plan view illustrating an overall configuration of an electrophoretic display device 100.

As illustrated in FIG. 1A, in the electrophoretic display device 100 of this embodiment, an element substrate 300 has a planar dimension larger than a counter substrate 310. On the element substrate 300 protruding more than the counter substrate 310, two scanning line driving circuits 61 and two data line driving circuits 62 are mounted as COF (Chip On Film) mountings (or TAB (Tape Automated Bonding) mounting) on flexible substrates 201 and 202 for connection with external devices. The flexible substrates 201 with the scanning line driving circuits 61 mounted thereon are mounted in a terminal-forming region that is formed on a peripheral edge along one short side of the element substrate 300, with an ACP (Anisotropic Conductive Paste), an ACF (Anisotropic Conductive Film), or the like therebetween. Here, the element substrate 300 is made of a first substrate 30 to be described later as a base, and the counter substrate 310 is made of a second substrate 31 to be described later as a base.

Also, the flexible substrates 202 with the data line driving circuits 62 mounted thereon are mounted in a terminal-forming region that is formed on a peripheral edge along one long side of the element substrate 300, with an ACP, an ACF, or the like therebetween. In each of the terminal forming regions, a plurality of connecting terminals are formed. Data lines and scanning lines to be described later that extend from a display section 5 are connected to the connecting terminals.

The display section 5 is formed in an area where the element substrate 300 and the counter substrate 310 overlap each other. Wires (scanning lines 66 and data lines 68) extending from the display section 5 stretch to the region where the scanning line driving circuit 61 and the data line driving circuit 62 are mounted, and the wires are connected to the connecting terminals formed in that mounting region. The flexible substrates 201 and 202 are mounted to such connecting terminals with an ACP, an ACF, or the like.

FIG. 1B is an equivalent circuit diagram illustrating the overall configuration of the electrophoretic display device.

As illustrated in FIG. 1B, a plurality of pixels 40 are arranged in a matrix in the display section 5 of the electrophoretic display device 100. The scanning line driving circuit 61 and the data line driving circuit 62 are disposed around the display section 5. The scanning line driving circuit 61 and the data line driving circuit 62 are each connected to a controller (not illustrated). The controller comprehensively controls the scanning line driving circuit 61 and the data line driving circuit 62 on the basis of image data and synchronizing signals supplied from a higher level device.

In the display section 5, a plurality of scanning lines 66 extending from the scanning line driving circuit 61 and a plurality of data lines 68 extending from the data line driving circuit 62 are formed, and the pixels 40 are provided so as to correspond to intersections of the scanning lines 66 and the data lines 68. Two different data lines (a data line 68A and a data line 68B) are connected to the pixel 40.

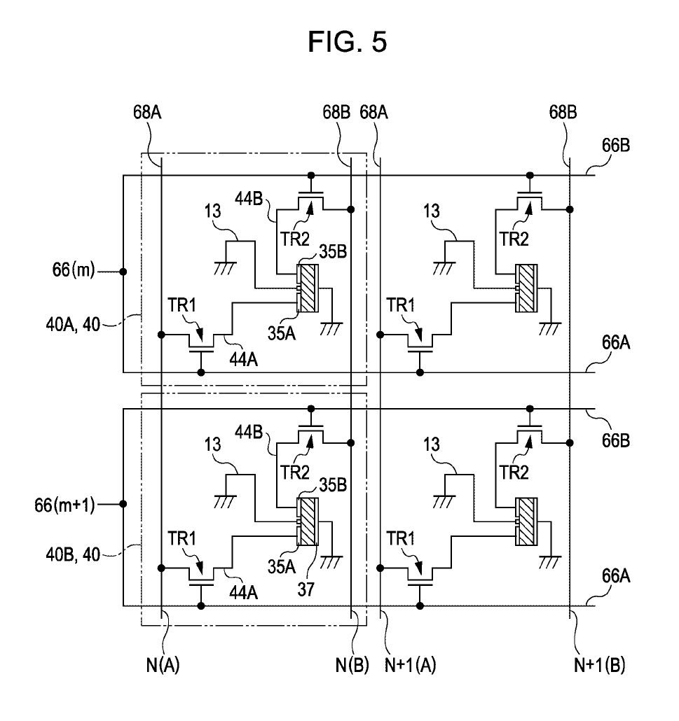

The scanning line driving circuit 61 is connected through the plurality of scanning lines 66 to the pixels 40. Under the control of the controller, the scanning line driving circuit 61 sequentially selects the scanning lines 66, and supplies to the selected scanning line 66 selection signals that control turn-on timings of select transistors TR1 and TR2 (see FIG. 5) provided in the pixel 40. The data line driving circuit 62 is connected through the plurality of data lines 68 to the pixels 40. Under the control of the controller, the data line driving circuit 62 supplies to each pixel 40 image signals that specify pixel data corresponding to that pixel 40.

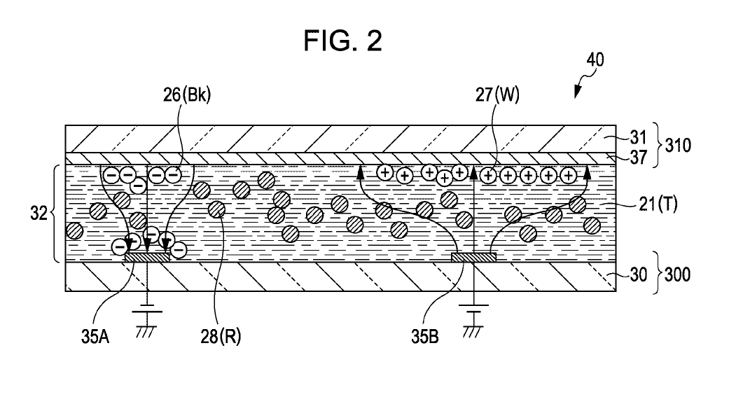

FIG. 2 is a partial sectional view illustrating a structure in one pixel of the electrophoretic display device.

As illustrated in FIG. 2, in the electrophoretic display device 100, an electrophoretic layer 32 is sandwiched between the element substrate 300 and the counter substrate 310. On the one hand, the element substrate 300 includes the first substrate 30. On a surface on the side of the electrophoretic layer 32 of the first substrate 30, a plurality of pixel electrodes 35A (first electrodes) and a plurality of pixel electrodes 35B (third electrodes), both of which are shaped like islands, are formed (FIG. 2 illustrating one pixel electrode 35A and one pixel electrode 35B). On the other hand, the counter substrate 310 includes the second substrate 31. On a surface on the side of the electrophoretic layer 32 of the second substrate 31, a counter electrode 37 (a second electrode) is formed. The counter electrode 37 covers the pixel electrodes 35A and 35B in plan view, and is formed of an area larger than those of the pixel electrodes 35A and 35B in plan view. Here, the counter electrode 37 is formed in an area covering at least portions contributing to display of the counter substrate 310.

The electrophoretic layer 32, which is formed between the pluralities of pixel electrodes 35A and 35B and the counter electrode 37, includes negatively charged particles 26(Bk), which are negatively charged and black in color, positively charged particles 27(W), which are positively charged and white in color, and uncharged particles 28(R), which are not charged and red in color, mixed in a transparent dispersion medium 21(T). The positively and negatively charged particles 26 and 27 behave as electrophoretic particles in the electrophoretic layer 32.

When a positive voltage is applied to the pixel electrode 35A, the negatively charged particles 26(Bk) accumulate on the pixel electrode 35A whereas when a negative voltage is applied to the pixel electrode 35B, the positively charged particles 27(W) accumulate on the pixel electrode 35B. It is to be noted that a ground potential as a common potential is applied to the counter electrode 37.

Here, it will be considered how electrophoretic particles are distributed on the counter electrode 37 depending on the polarities and the magnitudes of voltages applied to the pixel electrodes 35A and 35B. Among positive voltages applied to either one of the pixel electrodes 35A and 35B, a voltage whose absolute value is maximum is referred to as a “voltage VH (hereinbelow referred to also as a “maximum positive value”). Among negative voltages applied to the other, a voltage whose absolute value is the maximum is referred to as a “voltage VL” (hereinbelow referred to also as a “maximum negative value”). It is to be noted that “applying a voltage to an electrode” is synonymous with “supplying to an electrode a potential that causes that voltage to be generated between the potential and the ground potential”.

As illustrated in FIG. 2, when a medium negative voltage V1 (|Vl|<|VL|) is applied to the pixel electrode 35A, the particles 26(Bk) that are negatively charged move to the side of the counter electrode 37 by an electric field due to a potential difference (voltage) between a potential corresponding to the voltage Vl and the ground potential of the counter electrode 37. The voltage is not very large, and therefore the particles 26(Bk) are not widely distributed on the side of the counter electrode 37. This is because of the following reason. That is, the particles 26(Bk) move even by a diagonal electric field (a field having electric force lines that radiate from the pixel electrode 35A and in a direction inclined with respect to the first substrate 30). However, the original electric field is not large, and therefore the diagonal electric field is not large. Thus, the amount of movement of the particles 26(Bk) in a direction parallel to the second substrate 31 decreases, and the particles are concentrated in a narrow range. This allows the realization of a spot distribution. The number of particles also decreases. Thus, black display in a small area can be expressed here.

In contrast, when a large positive voltage VH (the maximum positive value) is applied to the pixel electrode 35B, the potential difference (voltage) between the pixel electrode 35B and the counter electrode 37 is larger than that in the case of voltage application to the pixel electrode 35A, and therefore a large electric field is generated between the pixel electrode 35B and the counter electrode 37. For this reason, almost all the positively charged particles 27(W) move to the side of the second substrate 31. With the increase in electric field, a diagonal electric field from the pixel electrode 35B also increases. The increased diagonal electric field causes the positively charged particles 27(W) to be dispersed in a wider range in a direction parallel to the second substrate 31. As a result, the distribution range of the positively charged particles 27(W) expands in plan view. Thus, on the pixel electrode 35B, white display can be expressed in an area larger than the black display on the pixel electrode 35A.

It is to be noted that in the case of not moving the negatively charged particles 26(Bk) and the positively charged particles 27(W) to the counter electrode 37, that is, in the case where the positive voltage VH is applied to each pixel electrode 35A, and the negative voltage VL is applied to each pixel electrode 35B, so that all the particles 26(Bk) accumulate on the pixel electrode 35A, and all the positively charged particles 27(W) accumulate on the pixel electrode 35B, the color of the uncharged particles 28(R), which is red in color, is visually recognized from the side of the second substrate 31. Therefore, the entire pixel is displayed in red.

In this way, the numbers and the distribution states (distribution areas) of the negatively charged particles 26(Bk) and the positively charged particles 27(W) that are to arrive at the counter electrode 37 are controlled. This makes it possible to control black display, white display, red display, or display of an intermediate gray-scale from dark red to light red. Further, the pluralities of island-shaped pixel electrodes 35A and 35B are provided in one pixel, which makes it possible to give greater control over display.

Hereinbelow, detailed control will be described.

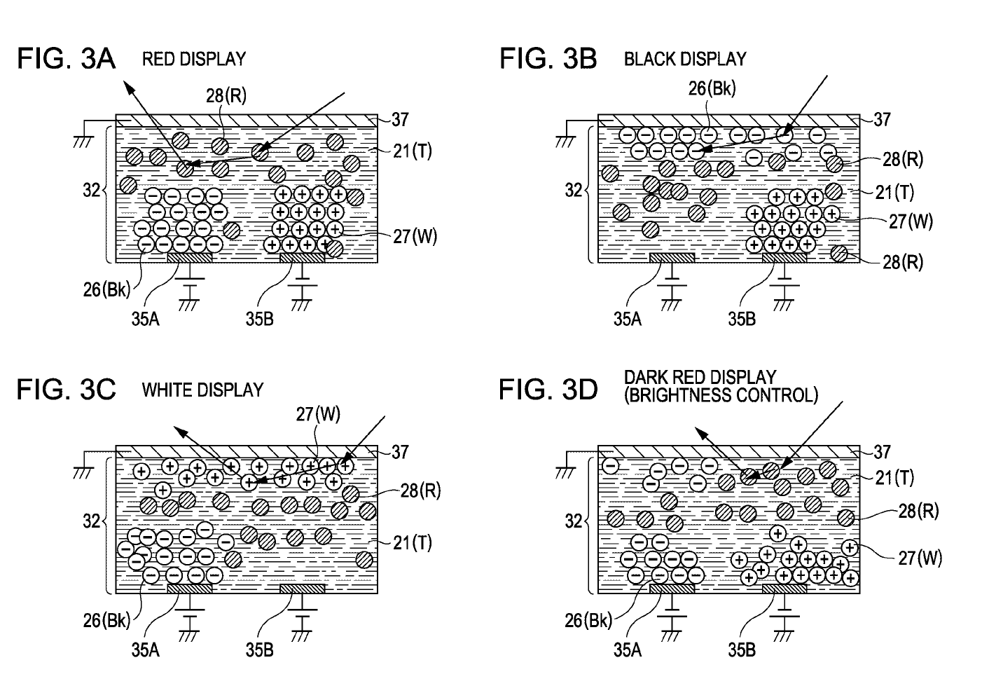

FIGS. 3A through 3D are explanatory illustrations illustrating distribution states of particles during driving in the electrophoretic display device.

In FIG. 3A, the positive voltage VH (the maximum positive value) is applied to the pixel electrode 35A, and the negative voltage VL (the maximum negative value) is applied to the pixel electrode 35B. In this case, the negatively charged particles 26(Bk) accumulate on the pixel electrode 35A, and the positively charged particles 27(W) accumulate on the pixel electrode 35B. Only the red color of the uncharged particles 28(R) is visually recognizable when viewed from the side of the counter electrode 37. Thus, the entire pixel is displayed in red here. The arrows in the drawing indicate a manner in which incident light is scattered, and the incident light is absorbed into the uncharged particles 28(R) of red.

In FIG. 3B, with respect to the red display state illustrated in FIG. 3A, the negative voltage VL (the maximum negative value) is applied to each of the pixel electrodes 35A and 35B. In this case, almost all the negatively charged particles 26(Bk) move to the side of the counter electrode 37 and are distributed on the counter electrode 37. The negatively charged particles 26(Bk) are distributed two dimensionally or three dimensionally on the side of the counter electrode 37. When the electrophoretic layer 32 is viewed from the side of the counter electrode 37, the color of many negatively charged particles 26(Bk) is visually recognizable. Thus, the entire pixel is displayed in black here. As indicated by the arrows in the drawing, the incident light is absorbed into the negatively charged particles 26(Bk), and, as a result, black display is realized.

In FIG. 3C, with respect to the red display state illustrated in FIG. 3A, the positive voltage VH (the maximum positive value) is applied to each of the pixel electrodes 35A and 35B. In this case, almost all the positively charged particles 27(W) move to the side of the counter electrode 37 and are distributed on the counter electrode 37. The positively charged particles 27(W) are distributed two dimensionally or three dimensionally on the side of the counter electrode 37. When the electrophoretic layer 32 is viewed from the side of the counter electrode 37, the color of many positively charged particles 27(W) is visually recognizable. Thus, the entire pixel is displayed in white here. As indicated by the arrows in the drawing, the incident light is scattered once or a plurality of times by the positively charged particles 27(W) and returns to an observation side. Therefore, a white color is shown as mentioned above. As such, even though the positively charged particles 27(W) themselves are particles having translucency, the incident light is scattered on the observation side by the positively charged particles 27(W), and thus white display is obtained.

In FIG. 3D, with respect to the red display state illustrated in FIG. 3A, the negative voltage VL is applied to the pixel electrode 35B, and the negative voltage V1 (|Vl|<|VL|) that is smaller in absolute value than the negative voltage applied at the time of black display (FIG. 3B) is applied to the pixel electrode 35A. In this state, some negatively charged particles 26(Bk) of black adsorbed on the pixel electrode 35A move to the side of the counter electrode 37. The counter electrode 37 is partially covered with the negatively charged particles 26(Bk) of black that have moved to the side of the counter electrode 37, and therefore the colors of the negatively charged particles 26(Bk) and the uncharged particles 28(R) are visually recognizable when the electrophoretic layer 32 is viewed from the side of the counter electrode 37. Thus, the entire pixel is displayed in dark red here.

In this way, the amount of movement of the negatively charged particles 26(B) of black to the side of the counter electrode 37 is controlled by using the magnitude of the applied voltage, so that the brightness is controlled.

It is noted that the amount of movement and the distribution range of the negatively charged particles 26(Bk) in FIG. 3C can be controlled by adjusting design factors, such as the distance between the pixel electrodes 35A and 35B and the size of the pixel electrodes 35A and 35B, and voltages to be applied.

It is also noted that while, in the description with reference to FIGS. 3A through 3D, the amounts of movement and the distribution ranges of the particles 26(Bk) and 27(W) are controlled by using the magnitudes of voltages applied to the pixel electrodes 35A and 35B, the amount of movement and the distribution range can also be controlled by using the length of duration of voltage application.

Saturation is controlled by using the area of the particles 27(W) or the area of the uncharged particles 28(R) visually recognized when the electrophoretic layer 32 is viewed from the outside of the counter electrode 37. To realize white display with the particles 27(W), incident light needs to be scattered a plurality of times by particles, and therefore the three-dimensional distribution in a depth direction of the particles is needed in the electrophoretic layer 32. The visually recognized area mentioned above refers to the effective area that includes the two-dimensional and three-dimensional distributions of particles and that is actually being seen.

As described above, the amounts of movement and the distribution ranges of the negatively charged particles 26(Bk) and the positively charged particles 27(W) are controlled. This enables control of the brightness and saturation in each pixel.

Although described above, the shift among states illustrated in FIGS. 3B, 3C and 3D is made via control of the state illustrated in FIG. 3A. That is, when some display is provided and then the display is to be changed, the positive voltage VH is applied to the pixel electrode 35A, and the negative voltage VL is applied to the pixel electrode 35B, so that all the negatively charged particles 26(Bk) accumulate on the pixel electrode 35A, and all the positively charged particles 27(W) accumulate on the pixel electrode 35B (red display: the pre-set state).

Subsequently, certain voltages are applied to the pixel electrodes 35A and 35B, respectively, to provide black display (FIG. 3B), white display (FIG. 3C), or dark red display (FIG. 3D).

Next, the pre-set state will be described.

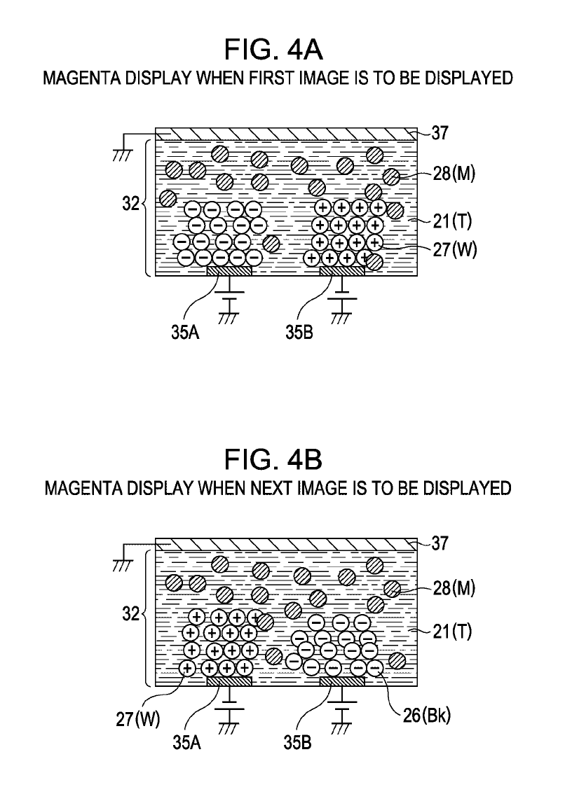

The electrophoretic display device illustrated in FIGS. 4A and 4B includes the electrophoretic layer 32 in which uncharged particles 28(M) of a magenta color are held instead of the uncharged particles 28(R) of a red color.

In this electrophoretic display device, the polarities of voltages to be applied to the pixel electrodes 35A and 35B, respectively, are reversed between a pre-set state for displaying a first image and a pre-set state for displaying the next image.

First, in the pre-set state for displaying the first image, as illustrated in FIG. 4A, the positive voltage VH is applied to the pixel electrode 35A, and the negative voltage VL is applied to the pixel electrode 35B. As a result, the negatively charged particles 26(Bk) gather on the pixel electrode 35A, and the positively charged particles 27(W) gather on the pixel electrode 35B. When the electrophoretic layer 32 is viewed from the side of the counter electrode 37, the color of the uncharged particles 28(M) is visually recognizable. Thus, magenta display is realized (a first pre-set state).

Next, in the pre-set state for displaying the next image, as illustrated in FIG. 4B, the negative voltage VL is applied to the pixel electrode 35A, and the positive voltage VH is applied to the pixel electrode 35B. As a result, the positively charged particles 27(W) gather on the pixel electrode 35A, and the negatively charged particles 26(Bk) gather on the pixel electrode 35B. When the electrophoretic layer 32 is viewed from the side of the counter electrode 37, the color of the uncharged particles 28(M) is visually recognizable. The same magenta display as in the preceding first pre-set state is realized.

FIG. 5 is an equivalent circuit diagram illustrating a specific configuration example in the first embodiment.

As illustrated in FIG. 5, in the electrophoretic display device 100 of this embodiment, a plurality of scanning lines 66 and pluralities of data lines 68A and 68B are provided on the first substrate 30. Here, the scanning line 66 of this embodiment includes a first scanning line 66A and a second scanning line 66B. The scanning line 66 branches into the two scanning lines 66A and 66B in a display region.

In one pixel 40, two select transistors, that is, a select transistor TR1 (a first transistor) and a select transistor TR2 (a second transistor), the electrophoretic layer 32 formed of an electrophoretic material, the two pixel electrodes 35A and 35B, the counter electrode 37, a connecting electrode 44A (a first connecting electrode), a connecting electrode 44B (a second connecting electrode), and a control electrode 13 are included.

The select transistor TR1 has a gate to which the first scanning line 66A is connected, a source to which the data line 68A is connected, and a drain to which the pixel electrode 35A (the electrophoretic layer 32) is connected. The select transistor TR2 has a gate to which the second scanning line 66B is connected, a source to which the data line 68B is connected, and a drain to which the pixel electrode 35B (the electrophoretic layer 32) is connected.

In the pixel 40A of the pixels 40A and 40B that are adjacent to each other in a direction along the data lines 68A and 68B, an mth scanning line 66 is connected to the gates of the select transistors TR1 and TR2. An N(A)th data line 68A is connected to the source of the select transistor TR1, and an N(B)th data line 68B is connected to the source of the select transistor TR2.

Here, it is possible to employ a configuration in which a storage capacitor is arranged between the drains of the select transistors TR1 and TR2 and a storage capacitor line (not illustrated). The storage capacitor line is formed, for example, at the same time as the scanning line 66 in a direction parallel to the scanning line 66. A measure other than the storage capacitor may be included for applying a voltage to the electrophoretic layer 32.

The connecting electrode 44A is connected to the drain of the select transistor TR1 and connected to the pixel electrode 35A, and the connecting electrode 44B is connected to the drain of the select transistor TR2 and connected to the pixel electrode 35B.

The control electrode 13 is present between the pixel electrodes 35A and 35B, and a voltage at nearly the same potential as the potential of the counter electrode 37 is applied to the control electrode 13. The control electrode 13 may be provided so as to correspond to each of the pixel electrodes 35A and 35B.

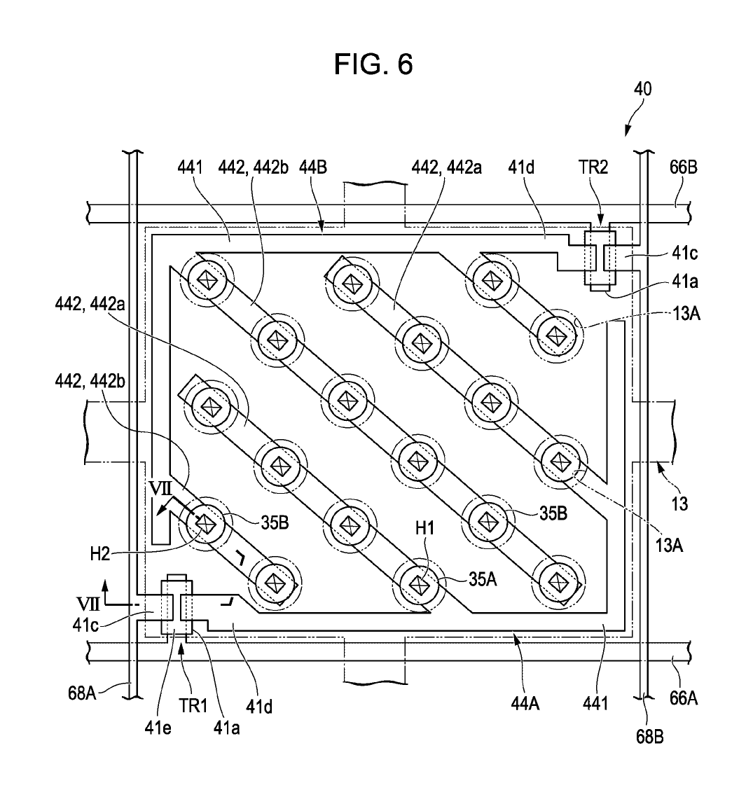

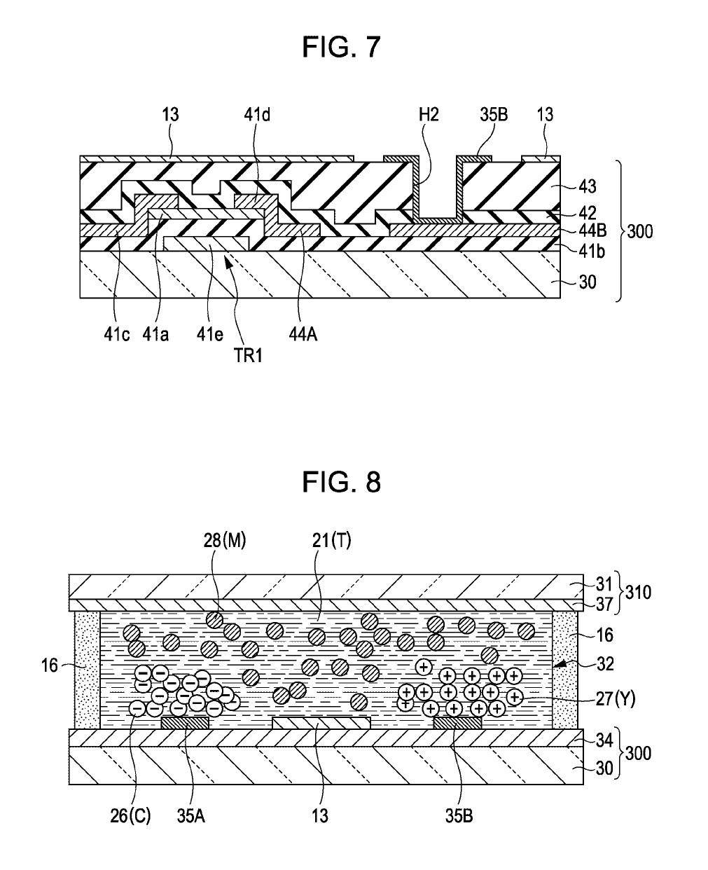

FIG. 6 is a plan view illustrating a specific configuration example of one pixel on the side of the element substrate of the first embodiment, and FIG. 7 is a sectional view taken along the line VII-VII of FIG. 6.

As illustrated in FIG. 6, the select transistors TR1 and TR2, the connecting electrodes 44A and 44B, the pixel electrodes 35A and 35B, and the control electrode 13 are provided for each pixel 40 on the first substrate 30.

A plurality of pixel electrodes 35A and a plurality of pixel electrodes 35B are provided, and each of the pixel electrodes 35A and each of the pixel electrodes 35B are circular in plan view. The plurality of pixel electrodes 35A, each of which is connected via a contact hole H1 to the connecting electrode 44A, are connected to one another with the connecting electrode 44A having a comb-teeth shape in plan view, and the plurality of pixel electrodes 35B, each of which is connected via a contact hole H2 to the connecting electrode 44B, are connected to one another with the connecting electrode 44B having a comb-teeth shape in plan view.

A drain electrode 41d of the select transistor TR1 is connected via the connecting electrode 44A to the plurality of pixel electrodes 35A, and the drain electrode 41d of the select transistor TR2 is connected via the connecting electrode 44B to the plurality of pixel electrodes 35B. A data potential from the data line 68A is applied via the select transistor TR1 to the plurality of pixel electrodes 35A, and a data potential from the data line 68B is applied via the select transistor TR2 to the plurality of pixel electrodes 35B. As such, the plurality of pixel electrodes 35A and the plurality of pixel electrodes 35B are configured to be driven independently of each other.

Each of the connecting electrodes 44A and 44B has a comb shape in plan view as mentioned above, and includes a main portion 441 made up of two sides extending along two directions (e.g., a direction along the scanning lines 66A and 66B and a direction along the data lines 68A and 68B) and having an overall V-like shape, and a plurality of branch portions 442 connected by using the main portion 441. The plurality of branch portions 442 extend parallel to one another in a direction (that is a direction at about 60 degrees to each side of the branch portion 442 here, and the direction is not limited to this direction and may be a direction at about 45 degrees to each side of the branch portion 442) different from the direction along the main portion 441. All the branch portions 442 are different in length from one another. The branch portion 442 extending from near the corner (bending portion) of the main portion 441 is the longest, and the more distant the branch portions are from the longest branch portion 442, the shorter the branch portions 442 are.

The connecting electrodes 44A and 44B having a comb shape in plan view are arranged in a meshing engagement with each other in the pixel 40. That is, the connecting electrodes 44A and 44B are in a state where the branch portions 442b of the connecting electrode 44B are present on both sides of the branch portion 442a of the connecting electrode 44A.

Each branch portion 442a of the connecting electrode 44A is provided for the plurality of pixel electrodes 35A, and each branch portion 442b of the connecting electrode 44B is provided for the plurality of pixel electrodes 35B. Thus, the plurality of pixel electrodes 35A are connected to one another with the connecting electrode 44A, and the plurality of pixel electrodes 35B are connected to one another with the connecting electrode 44B.

The control electrode 13 is formed in a solid manner over nearly the whole pixel region so as to cover the select transistors TR1 and TR2, and has pluralities of openings 13A and 13B having a circular shape in plan view at positions corresponding to the pixel electrodes 35A and 35B. The pixel electrodes 35A and 35B are present inside the openings 13A and 13B in plan view. The shapes of the openings 13A and 13B are circular in accordance with the shapes in plan view of the pixel electrodes 35A and 35B. With the diameter of the opening larger than that of the pixel electrode, the dimensions of the openings 13A and 13B are set so as to cause no short circuit between the pixel electrodes 35A and 35B and the control electrode 13.

The control electrode 13 is common to all the pixels 40. At the intersection of the control electrode 13 and the scanning line 66A, the scanning line 66B, the data line 68A, or the data line 68B, an area where the control electrode 13 overlaps the scanning line 66A, the scanning line 66B, the data line 68A, or the data line 68B is thinned and as narrow as possible, which is a measure for reducing a parasitic capacitance associated with the control electrode 13. This is effective for low power consumption. A voltage is applied to the control electrode 13 in the outside of the display section 5.

As illustrated in FIG. 7, the first substrate 30 is a glass substrate having a thickness of 0.6 mm, and, on a surface thereof, a gate electrode 41e (the scanning line 66A) made of aluminum (Al) and having a thickness of 300 nm is formed. A gate insulating film 41b made of a silicon oxide film and having a thickness of 400 nm is formed over the entire surface of the first substrate 30 in such a manner as to cover the gate electrode 41e, and a semiconductor layer 41a made of a-IGZO (an oxide of 1n, Ga, and Zn) and having a thickness of 50 nm is formed directly above the gate electrode 41e.

On the gate insulating film 41b, a source electrode 41c (the data line 68) and the drain electrode 41d that are made of Al and have a thickness of 300 nm are each provided so as to partly overlap the gate electrode 41e and the semiconductor layer 41a. The source electrode 41c and the drain electrode 41d are each formed in such a manner that part thereof is stranded on the semiconductor layer 41a. Also, like the source electrode 41c and the drain electrode 41d, the connecting electrodes 44A and 44B made of Al and having a thickness of 300 nm are formed on the gate insulating film 41b. The connecting electrodes 44A and 44B are patterned at the same time as the source electrode 41c and the drain electrode 41d, and the connecting electrode 44A (the connecting electrode 44B) is connected to the drain electrode 41d of the select transistor TR1 (the select transistor TR2: FIG. 6).

Here, as the select transistor TR1 (TR2: FIG. 6), a typical a-Si TFT, a poly SiTFT, an organic TFT, an oxide TFT, or the like may be used. As the structure of the select transistor TR1 (TR2: FIG. 6), either a top-gate structure or a bottom-gate structure may be used.

An interlayer insulating film 42 made of silicon oxide and having a thickness of 300 nm and an interlayer insulating film 43 made of photosensitive acryl and having a thickness of 1 μm are formed on the select transistor TR1 (TR2: FIG. 6) and the connecting electrodes 44A and 44B such that the interlayer insulating films cover the select transistor TR1 (TR2: FIG. 6) and the connecting electrodes 44A and 44B. As the material for the interlayer insulating film 43, acryl is used. However, other materials may be used, and inorganic insulating films such as a silicon oxide film and organic insulating films may also be used. The interlayer insulating film 43 functions as a planarization film. It is to be noted that if the interlayer insulating film 42 can be provided with the functionality as a planarization film, the interlayer insulating film 43 is not necessarily needed, and may be omitted. The plurality of pixel electrodes 35B (35A: FIG. 6) made of ITO and having a thickness of 50 nm are provided via the contact holes H2 (H1: FIG. 6) formed in the interlayer insulating films 42 and 43. The control electrode 13 is provided in the same layer as the pixel electrode 35B, and is made of the same 50-nm-thickness ITO as the pixel electrode 35B.

As such, the element substrate 300 is made up of elements from the first substrate 30 to the pixel electrode 35B (35A: FIG. 6).

FIG. 8 is a sectional view illustrating a schematic structure in one pixel of the electrophoretic display device.

As illustrated in FIG. 8, the electrophoretic display device 100 of this embodiment includes the electrophoretic layer 32 sandwiched between the element substrate 300 having such a configuration as described above and the counter substrate 310, and, in the electrophoretic layer 32, a plurality of negatively charged particles 26(B) of black, a plurality of positively charged particles 27(W) of white, and a plurality of uncharged particles 28(R) of red are held in the transparent dispersion medium 21(T). More specifically, the electrophoretic layer 32 is sandwiched between the element substrate 300 including the elements from the first substrate 30 to the pixel electrodes 35A and 35B and the counter substrate 310 including the second substrate 31 and the counter electrode 37.

The counter electrode 37 facing the pluralities of pixel electrodes 35A and 35B has an area larger than the sum total of areas of the island-shaped pixel electrodes 35A and 35B, and forms one continuous electrode (planer solid electrode) at least in an area that contributes to display in a pixel. The counter electrode 37 may be provided with a notch portion without an electrode, as needed. The pixel electrode 35A and the pixel electrode 35B arranged in one pixel are configured to be driven independently of each other.

A sealing member 16 that is disposed so as to surround the entire perimeter of the display section 5 (FIG. 1A) in plan view is formed between the element substrate 300 and the counter substrate 310. The electrophoretic layer 32 is sealed with the element substrate 300, the counter substrate 310, and the sealing member 16. It is to be noted that the sealing member can be formed between the element substrate 300 and the counter substrate 310 so as to surround each pixel 40 in plan view.

Although not illustrated, the electrophoretic layer 32 partitioned into smaller regions can be used. For example, a capsule-type electrophoretic layer may be used. In this electrophoretic layer, a capsule is disposed between the pixel electrodes 35A and 35B and the counter electrode 37, and a dispersion medium and charged particles are enclosed in the capsule. Also, a configuration in which a dispersion medium and charged particles are enclosed in a region separated by a partition provided between the element substrate 300 and the counter substrate 310 may be used. In such a partitioned electrophoretic layer, operations similar to those in other examples can be performed. Positively and negatively charged particles of different colors can be used in either a capsule-type or non-capsule-type electrophoretic layer.

The electrophoretic layer 32 includes pluralities of particles of three types that are held in the transparent colorless dispersion medium 21(T). The particles of three types are the negatively charged particles 26(Bk) of black, the positively charged particles 27(W) of white, and the uncharged particles 28(R) of red.

The constituent material of a transparent electrode to be used as the counter electrode 37, the pixel electrode 35A, or the pixel electrode 35B is not limited as long as it is a substantially conductive material. Examples of such a conductive material include metallic materials such as copper, aluminum, and alloys containing these metals; carbon-based materials such as carbon black; electron conducting polymeric materials such as polyacetylene, polypyrrole, and derivatives thereof; ion-conducting polymeric materials in which an ionic substance such as NaCl, LiClO₄, KCl, LiBr, LiNO₃ or LiSCN is dispersed in a matrix resin such as polyvinyl alcohol, polycarbonate, or polyethylene oxide; and conductive oxide materials such as indium-tin-oxide (ITO), fluorine-doped tin oxide (FTO), tin oxide (SnO₂), and indium oxide (IO). These conductive materials can be used in combination of one type, or two or more types.

It is to be noted that the pixel electrodes 35A and 35B are positioned on the side opposite the viewing side, and therefore the electrode material for the pixel electrodes 35A and 35B need not be transparent, and paste or the like of metal, silicide, silver, or the like may be used.

It is preferable that the material for the dispersion medium 21 be substantially colorless and transparent. As such a dispersion medium, a material having relatively high insulating properties is preferably used. Examples of such a material for the dispersion medium include various types of water (e.g., distilled water, pure water, and ion-exchanged water); alcohols such as methanol, ethanol, and butanol; cellosolves such as methyl cellosolve; esters such as methyl acetate and ethyl acetate; ketones such as acetone and methyl ethyl ketone; aliphatic hydrocarbons such as pentane; alicyclic hydrocarbons such as cyclohexane; aromatic hydrocarbons such as benzenes having a long chain alkyl group (e.g., benzene and toluene); halogenated hydrocarbons such as methylene chloride and chloroform; heteroaromatic rings such as pyridine and pyrazine; nitriles such as acetonitrile and propionitrile; amides such as N,N-dimethylformamide; mineral oils such as carboxylate and liquid paraffin; vegetable oils such as linoleic acid, linolenic acid, and oleic acid; silicone oils such as dimethyl silicone oil, methylphenyl silicone oil, and methyl hydrogen silicone oil; fluorine liquids such as hydrofluoroether; and other various types of oils. These can be used singly or as a mixture. As the dispersion medium 21, gas or vacuum may be used.

When needed, various types of additives may be added into the dispersion medium 21. Examples of the additives include an electrolyte; a surface acting agent; a charge control agent composed of particles of metal soap, a resin material, a rubber material, oils, varnish, and compounds; dispersion agents of coupling agents such as a titanium coupling agent, an aluminum coupling agent, and a silane coupling agent; lubricant agents; and stabilizing agents.

As the charged particles, uncharged particles and transparent particles included in the dispersion medium 21, any particles may be used. There is no particular limitation on these particles. However, at least one type of dye particles, pigment particles, resin particles, ceramic particles, metallic particles, metallic oxide particles, and composite particles of these particles is preferably used. These particles have advantages in that they can be manufactured with ease, and charging can be controlled with relative ease.

Examples of a pigment of which a pigment particle is made include black pigments such as aniline black, carbon black, and titanium black; white pigments such as titanium dioxide, antimony trioxide, zinc sulfide, and zinc white; azo pigments such as monoazo, disazo, and polyazo; yellow pigments such as isoindolinone, chrome yellow, yellow oxide, cadmium yellow, and titan yellow; red pigments such as quinacridone red and chrome vermilion; blue pigments such as phthalocyanine blue, indanthrene blue, iron blue, ultramarine blue, and cobalt blue; green pigments such as phthalocyanine green; cyan pigments such as ferric ferrocyanide; and magenta pigments such as inorganic iron oxide. Inorganic pigments and organic pigments can also be used. These pigments can be used in combination of one type, or two or more types.

Dye particles can be made using dyes in place of the above-mentioned pigments. In this case, dye may be mixed into a white pigment, and may also be mixed with a color pigment. For example, dyes such as carbonium-based magenta can be used.

Examples of a resin material of which resin particles are made include acrylic resins, urethane resins, urea resins, epoxy resins, rosin resins, polystyrene, polyester, an ABS resin produced by copolymerizing styrene and acrylonitrile. These resin materials can be used in combination one type, or two or more types.

Examples of the composite particles include particles produced by coating the surfaces of the pigment particles with a resin material, particles produced by coating the surfaces of the resin particles with a pigment, and particles made of a mixture in which a pigment and a resin material are mixed in an appropriate composition ratio. As various particles contained in the dispersion medium 21, particles having such a structure that the center of the particle is hollow may be used. Such a structure allows light to be scattered from the surface of a particle, and, in addition, allows light to be scattered from a wall surface forming the hollow inside the particle. This enables improvement of the scattering efficiency of light. Thus, color reproduction for white and other colors can be improved.

For the purpose of improving the dispersibility of such electrophoretic particles in the dispersion medium 21, it is possible to cause polymers having a high compatibility with the dispersion medium 21 to be physically absorbed and chemically bonded onto the surfaces of particles. Among these structures, it is particularly preferable that polymers be chemically bonded, in view of their attachment to and removal from the surfaces of electrophoretic particles. Such a structure acts on decreasing the apparent gravity of electrophoretic particles. This can cause the affinity, that is, dispersibility of electrophoretic particles in the dispersion medium 21 to be improved.

Examples of such a polymer include polymers that have groups reacting with electrophoretic particles, and charged functional groups; polymers that have groups reacting with electrophoretic particles, and long alkyl chains, long ethylene oxide chains, long alkyl fluoride chains, long dimethyl silicone chains, and the like; and polymers that have groups reacting with electrophoretic particles, charged functional groups, and long alkyl chains, long ethylene oxide chains, long alkyl fluoride chains, long dimethyl silicone chains, and the like.

In the polymers as described above, examples of groups reacting with electrophoretic particles include an epoxy group, a thioepoxy group, an alkoxysilane group, a silanol group, an alkylamido group, an aziridine group, an oxazin group, and an isocyanate group. One type, or two or more types of these groups can be selected and used. Selection may be made in accordance with the type and the like of electrophoretic particles to be used.

The average diameter of electrophoretic particles is preferably from about 0.01 to 10 μm, and more preferably from 0.02 to 5 μm.

As the first substrate 30 and the second substrate 31, an organic insulating substrate other than a PET (Ethylene Terephthalate) substrate, an inorganic glass substrate such as a thin glass plate, or a composite substrate made of an inorganic material and an organic material may be used.

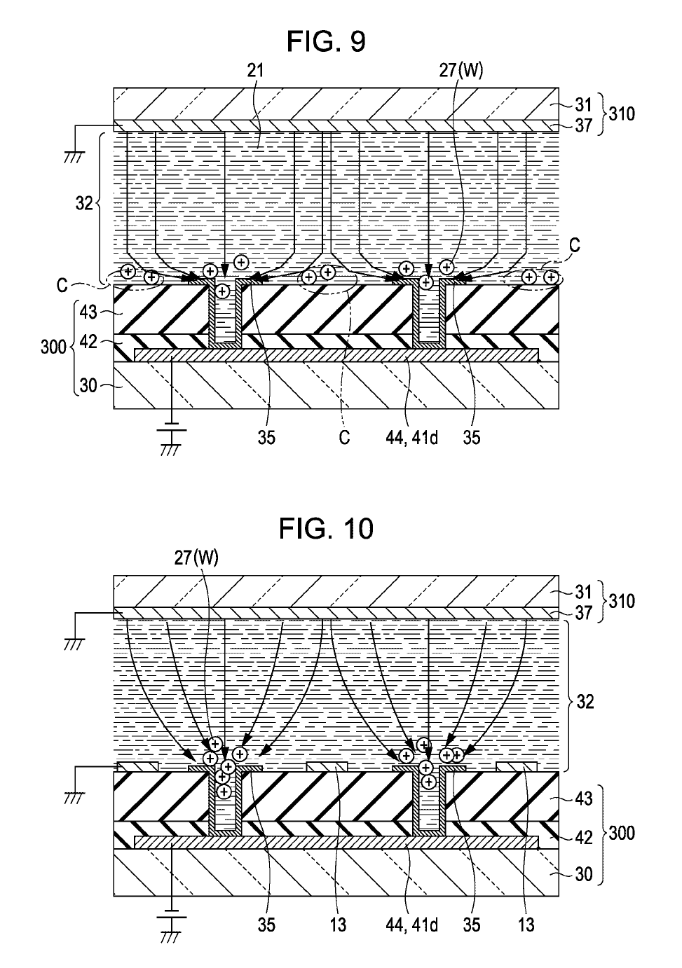

FIG. 9 is a partial sectional view illustrating a schematic structure of an existing electrophoretic display device, and FIG. 10 is a partial sectional view illustrating a schematic structure of the electrophoretic display device of this embodiment.

As illustrated in FIG. 9, typically, the cell gap (the distance between the counter substrate 310 and the element substrate 300) of an electrophoretic display device is about 40 μm, and the thickness of the interlayer insulating film 42 on the side of the element substrate 300 is from 0.3 to 0.4 μm, and the thickness of the interlayer insulating film 43 is from about 1 to 2 μm.

In such an existing electrophoretic display device, when the negative voltage VL (the maximum negative voltage) is applied to each of the plurality of pixel electrodes 35 connected via a connecting electrode 44, the charged particles 27(W) distributed on the side of the counter electrode 37 move perpendicularly to a substrate surface and are drawn to the side of the element substrate 300.

In FIG. 9, lines of electric force extend from the counter electrode 37 toward the pixel electrodes 35; however, lines of electric force from the counter electrode 37 corresponding to positions between the pixel electrodes 35 extend vertically toward the side of the element substrate 300 and sharply bend in directions toward the pixel electrodes 35 in the vicinity of the element substrate 300.

The positively charged particles 27(W) move along the lines of electric force around the beginning. The positively charged particles 27(W), however, cannot follow the sharp bending on the surface of the element substrate 300. A phenomenon where the positively charged particles 27(W) stay in areas C illustrated in FIG. 9 and are adhered onto the element substrate 300 is observed. To cause the positively charged particles 27(W) to move onto the pixel electrodes 35, a high voltage that is two or more times an existing applied voltage (about ±15 V) needs to be applied. Even such a high voltage, however, cannot cause all the retained particles to move. The number of the positively charged particles 27(W) that can be controlled decreases, which results in a display problem. Further, the numbers of the positively charged particles 27(W) left in the areas C are uneven in the pixel region, and therefore uneven display appears.

The cause of such a phenomenon is considered as follows.

The capacitance produced by the dispersion medium 21 in the electrophoretic layer 32 is far smaller than a composite capacitance of the interlayer insulating films 42 and 43. The reason for such smallness is that although the interlayer insulating films 42 and 43 and the electrophoretic layer 32 have dielectric constants of from about 2 to 7, which does not produce a large difference, the electrophoretic layer 32 has a thickness of from 40 to 50 μm, the interlayer insulating film 42 has a thickness of about 300 nm, and the interlayer insulating film 43 has a thickness of about 1.5 μm such that the thicknesses of the interlayer insulating films 42 and 43 and the thickness of the electrophoretic layer 32 differ by an order of magnitude or more. For this reason, most of a voltage between the connecting electrode 44 (the drain electrode) and the counter electrode 37 is applied to the dispersion medium 21 of the electrophoretic layer 32. Therefore, the particles behave as if two interlayer insulating films 42 and 43 were absent. However, the lines of electric force are near the counter electrode 37. Therefore, the particles near the counter substrate 310 move vertically toward the element substrate 300.

However, as the moving positively charged particles 27(W) approach the element substrate 300, the thickness of the electrophoretic layer 32 decreases as seen from the positively charged particles 27(W), and it becomes impossible to neglect the two interlayer insulating films 42 and 43. This means that a voltage is applied to the two interlayer insulating films 42 and 43, and, as a result, the vertical electric field in the dispersion medium 21 is relatively decreased. At this point, the electric field in a diagonal direction from the pixel electrodes 35 exposed in the dispersion medium 21 is relatively strong, and therefore lines of electric force are formed toward the pixel electrodes 35. The positive charged particles 27 move along this direction. However, from the aforementioned reason, this effect is exerted only after the remaining thickness of the dispersion medium 21 becomes equal to the total thickness of the two interlayer insulating films 42 and 43. Therefore, as described above, the positively charged particles 27 that do not bend toward the pixel electrodes 35 are left behind in the areas C.

As such, the existing structure has a problem in that the particles 27 cannot be satisfactorily controlled. For example, some positively charged particles 27 do not gather on the pixel electrodes 35, and are fixed in the areas C and do not move. Also, as described above, it is found that a high voltage is required for moving the fixed charged particles 27.

For the purpose of solving the above problem, in the electrophoretic display device of this embodiment illustrated in FIG. 10, the control electrodes 13 are provided in the areas C that are around the pixel electrodes 35 and in which the positively charged particles 27 are likely to be retained. The control electrode 13 is at the same potential as the counter electrode 37, which allows formation of lines of electric force from the vicinity of the counter electrode 37 toward the pixel electrode 35. Then, the particles 27 start moving from the counter electrode 37 toward the side of the pixel electrode 35 in accordance with such lines of electric force. The charged particles 27 moving to the side of the element substrate 300 are repelled toward the side of the pixel electrode 35 by the control electrode 13 that is at the same potential as the counter electrode 37.

In this way, with the structure of this embodiment, the control electrode 13 is provided, so that the potential is controlled in the area C. This results in smooth movement of the positively charged particles 27. Thus, the charged particles 27 can be prevented from being retained in the area C.

According to this embodiment, combining colored particles with a colored dispersion medium and the like enables color display. With the magnitudes and the durations of voltages to be applied to the pixel electrodes 35A and 35B, the two-dimensional or three-dimensional distribution of the negatively charged particles 26 and the positively charged particles 27 on the counter electrode 37 can be controlled. Thus, the gray scale of a displayed color viewed from the side of the counter substrate 310 can be controlled. The gray scale of a displayed image is controlled by using the distribution ranges (dot sizes) of the particles 26 and 27 on the counter electrode 37, so that display of an arbitrary color can be realized.

### Method of Driving Electrophoretic Display Device

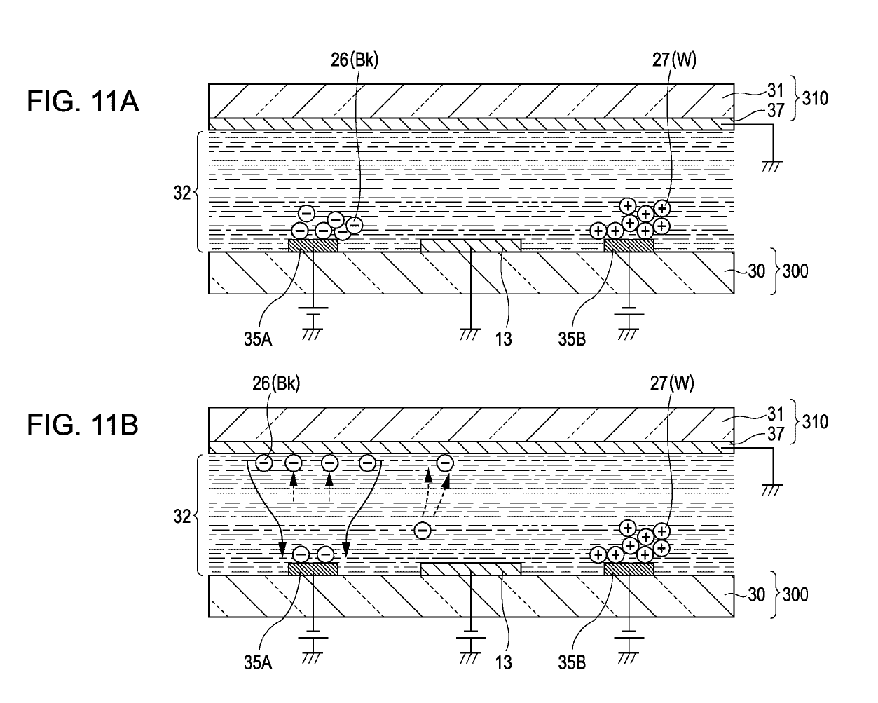

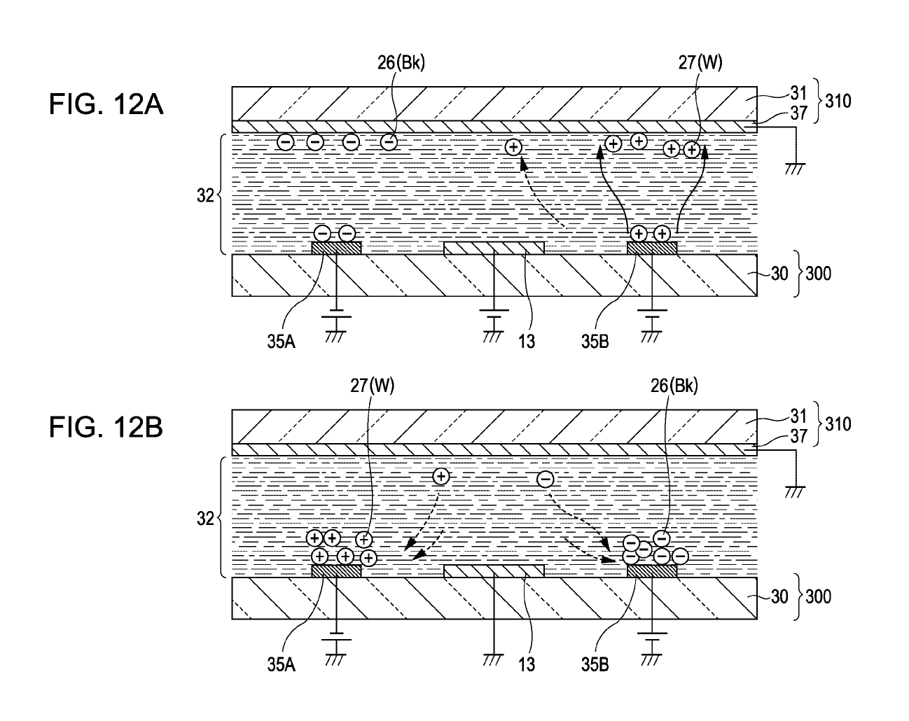

FIGS. 11A and 11B and FIGS. 12A and 12B are explanatory illustrations for a method of driving an electrophoretic display device. Here, a description will be given with a two-particle system of white particles and black particles taken as an example.

In a method of driving an electrophoretic display device of this embodiment, a first pre-set period T1, an image display period T2, and a second pre-set period T3 are assumed, and the polarities of voltages applied to the pixel electrodes 35A and 35B during the first pre-set period T1 are reversed during the second pre-set period T3.

FIG. 11A corresponds to FIG. 3A and illustrates a state that is referred to herein as a “rewrite pre-set state”.

In the first pre-set period T1, as illustrated in FIG. 11A, the positive voltage VH (the maximum positive value) is applied to the pixel electrode 35A, and the negative voltage VL (the maximum negative value) is applied to the pixel electrode 35B (a first pre-set operation), so that all the negatively charged particles 26(Bk) gather onto the pixel electrode 35A, and all the positively charged particles 27(W) gather onto the pixel electrode 35B. At this point, the control electrode 13 is set at the ground potential and, as a result, is at the same potential as the counter electrode 37, so that the charged particles 26 and 27 are prevented from being drawn onto (are repelled by) the control electrode 13.

In the image display period T2, in the case of gray display, as illustrated in FIG. 11B, the negative voltage V1 (|Vl|<|VL|) is applied to the pixel electrode 35A, and the negative voltage VL (the maximum negative value) is applied to the pixel electrode 35B, so that some negatively charged particles 26(Bk) move to the side of the counter electrode 37. Some negatively charged particles 26(Bk) are caused to be distributed on the counter electrode 37, whereas all the positively charged particles 27(W) are caused to gather on the pixel electrode 35B. At this point, a negative voltage is also applied to the control electrode 13 to repel the negatively charged particles 26(Bk) that are likely to be retained on the element substrate 300, which ensures that the repelled particles 26 arrive at the counter electrode 37. At this point, a negative voltage is also applied to the pixel electrode 35B, and therefore it is possible to more effectively cause the negatively charged particles 26(Bk) to arrive at the side of the counter electrode 37.

Next, as illustrated in FIG. 12A, with the negative voltage V1 (|Vl|<|VL|) remaining applied to the pixel electrode 35A, the positive voltage VH (Vh<VH) is applied to the pixel electrode 35B, so that some positively charged particles 27(W) are distributed on the counter electrode 37. At this point, a positive voltage is applied to the control electrode 13, so that positively charged particles 27 are repelled by the control electrode 13 and smoothly move to the side of the counter electrode 37.

In this way, some negatively charged particles 26(Bk) and some positively charged particles 27(W) are distributed on the counter electrode 37, so that gray display is obtained. In this case, as described above, display is performed using two operations illustrated in FIG. 11B and FIG. 12A.

In the second pre-set period T3, as illustrated in FIG. 12B, voltages of polarities opposite those of the applied voltages in the first pre-set period T1 are applied to the pixel electrodes 35A and 35B (a second pre-set operation). That is, a negative voltage is applied to the pixel electrode 35A, and a positive voltage is applied to the pixel electrode 35B, so that the positively charged particles 27(W) accumulate on the pixel electrode 35A, and the negatively charged particles 26(Bk) accumulate on the pixel electrode 35B. At this point, the control electrode 13 is set at the ground potential and, as a result, is at the same potential as the counter electrode 37, so that lines of electric force as illustrated in FIG. 10 are formed from the counter electrode 37 toward the pixel electrodes 35A and 35B. As a result, the positively charged particles 26 and 27 distributed on the counter electrode 37 smoothly move toward the side of the pixel electrodes 35A and 35B, and gather on the pixel electrodes 35B and 35A, respectively, without being retained on the element substrate 300. That is, the particles 26 and 27 that have moved onto the control electrode 13 are repelled in a lateral direction toward the pixel electrodes 35A and 35B. In this way, the positively charged particles 27(W) gather on the pixel electrode 35A, and the negatively charged particles 26(Bk) gather on the pixel electrode 35B.

It is to be noted that the counter electrode 37 is assumed to be at 0 V, the voltages applied to the pixel electrodes 35A and 35B are assumed such that their maximum voltages are |VL| and VH, and their minimum voltages are |Vl| and Vh, and the ground potential is assumed to be at 0 V.

Here, in cases where black display is performed using a three-particle system of black, white, and red particles as illustrated in FIG. 3B, with the state illustrated in FIG. 3A serving as the reference state, the negative voltage VL is applied to each of the pixel electrodes 35A and 35B, and the negative voltage VL is also applied to the control electrode 13.

In cases where white display as illustrated in FIG. 3C is performed, the positive voltage VH is applied to each of the pixel electrodes 35A and 35B, and the positive voltage VH is also applied to the control electrode 13.

In cases where dark red display as illustrated in FIG. 3D is performed, a negative voltage V1 (Vl=VL) is applied to the pixel electrode 35A, and the negative voltage VL is applied to the pixel electrode 35B. At the same time, the ground potential is applied to the control electrode 13.

According to the driving method of this embodiment, a voltage for repelling the charged particles 26 and 27 is applied to the control electrode 13 provided around the pixel electrodes 35A and 35B, so that the potentials in the areas (the above-mentioned areas C) where the charged particles 26 and 27 are likely to be retained are controlled. Accordingly, the charged particles 26 and 27 can smoothly move, and can be prevented from being retained.

In this embodiment, as illustrated in FIG. 6, the distance between the pixel electrode 35A or 35B and the control electrode 13 is fixed at any point, and there is no point such as an acute angle at which the electric field is concentrated, and therefore the charged particles 26 and 27 can be smoothly controlled.

Alternate current is applied to four electrodes, that is, the pixel electrodes 35A and 35B, the counter electrode 37, and the control electrode 13. As a result, corrosion of the electrodes 35A, 35B, 37, and 13, deterioration of the electrophoretic material, and the like can be prevented.

It is to be noted that the potential of the control electrode 13 is not necessarily limited to the same potential as the counter electrode 37 or the ground potential, and may be any potential at which, with respect to the potentials of the counter electrode 37 and the pixel electrodes 35A and 35B, the charged particles 26 and 27 can be repelled. Specifically, desirable is a voltage applied to the pixel electrode 35A or 35B or a voltage applied to the counter electrode 37 at the time of moving the negatively charged particles 26(Bk) and the positively charged particles 27(W), or a voltage between these voltages.

Also, as in this embodiment, the first pre-set operation and the second pre-set operation are alternately performed, which allows new display to be performed after the distribution state is once returned to the initial state. Thus, particles can move more smoothly than when display operation is continuously performed. This can lead to a stable shift of display.

Also, in cases where gray-scale display is performed, or when some black and white particles are caused to move to the side of the counter electrode 37 so as to bring about the state of dark red display illustrated in FIG. 3D, a data voltage is modulated. As means for modulating the data voltage, there are cited a method of setting voltages to be applied to the pixel electrodes 35A and 35B to be between VL and VH, and a method of varying the durations when applying the voltages VL and VH to the pixel electrode 35A and the pixel electrode 35B. The former method is referred to as “pulse-amplitude modulation”, and the latter method is referred to as “pulse-width modulation”, regarding liquid crystal devices. These modulation methods are typically performed within one frame period in the case of matrix driving. However, the pulse-width modulation may be performed over a plurality of frames.

In this embodiment, the gray scale is controlled using the actual area that is perceived when the distribution areas of the particles 26 and 27 on the counter electrode 37 are viewed from the side of the counter substrate 310. Thus, the brightness and the saturation are controlled.

Also, the voltages Vl and Vh are voltages required for, for example, causing black particles and white particles on one pixel electrode not to move, and causing particles on the other pixel electrode to move for a certain distance to a certain position toward the counter electrode 37. If the voltages Vl and Vh can achieve such objective, they would be satisfactory, irrespective of their polarities and magnitudes.

The above-described relation between magnitudes of voltages applied to the pixel electrodes 35A and 35B is one example. This is because the relation varies in accordance with the distance between the pixel electrodes 35A and 35B, the distance between the pixel electrode 35A or 35B and the counter electrode 37, and the electrophoretic material of the pixel electrodes 35A and 35B.

Further, reversal of polarities of voltages to be applied to the two pixel electrodes 35A and 35B in each pre-set period need not be performed once for each screen, but may be performed once for a plurality of screens.

### Method of Manufacturing Electrophoretic Display Device

Hereinbelow, a method of manufacturing an electrophoretic display device will be described.

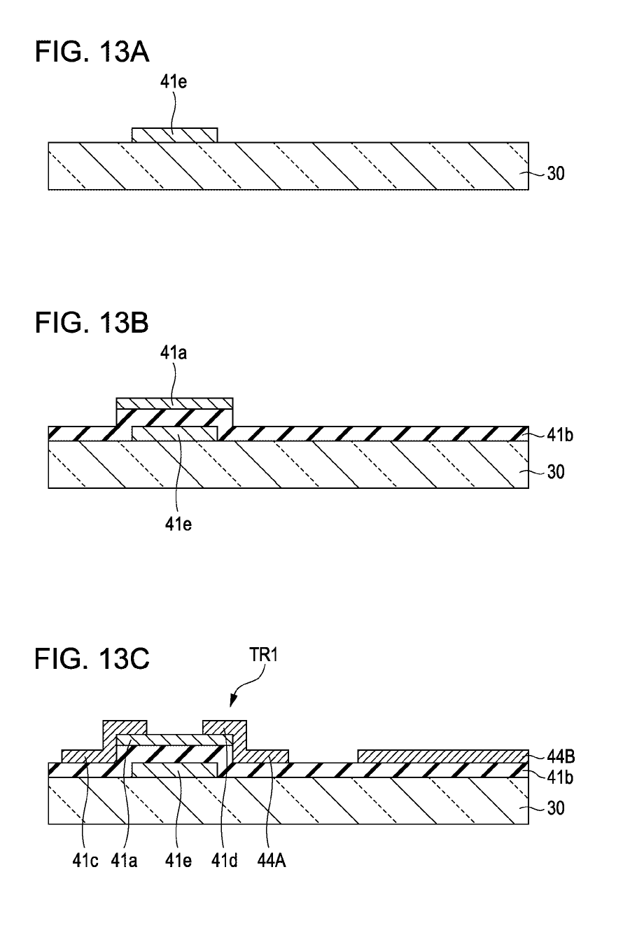

FIGS. 13A through 15 are partial sectional views for illustrating manufacturing processes for an electrophoretic display device.

It is to be noted that FIG. 6 and FIG. 7 will be referred to as appropriate in the following description.

First, as illustrated in FIG. 13A, a film of aluminum (Al) of 300 nm is formed over the entire surface of the element substrate 300 made of glass and having a thickness of 0.6 mm by sputtering, and the gate electrode 41e is formed by photoetching.

Next, as illustrated in FIG. 13B, a silicon oxide film having a thickness of 300 nm is formed over the entire substrate surface by plasma chemical vapor deposition (CVD), so that the gate insulating film 41b is formed. Thereafter, on the gate insulating film 41b, the semiconductor layer 41a having a thickness of 50 nm and being made of a-IGZO (an oxide of In, Ga, and Zn) is formed by sputtering. At this point, the semiconductor layer 41a is processed in an island shape in a photoetching process so that a portion of the semiconductor layer 41a directly above the gate electrode 41e is left. It is known that the source and drain regions of an oxide semiconductor are formed by themselves without impurity injection or the like. In this embodiment, impurity injection or the like is not performed. In addition, the formation of the semiconductor layer 41a need not be such continuous film formation in a vacuum as is performed for amorphous silicon.

Next, as illustrated in FIG. 13C, an aluminum (Al) film having a thickness of 300 nm is formed over the entire surface of the gate insulating film 41b by sputtering, and the aluminum film is patterned using photoetching, so that the source electrode 41c and the drain electrode 41d are each formed in such a manner that part thereof is stranded on the semiconductor layer 41a, and the connecting electrode 44A (44B) is formed. In this way, the transistor TR1 (TR2) and the connecting electrode 44A (44B) are formed.

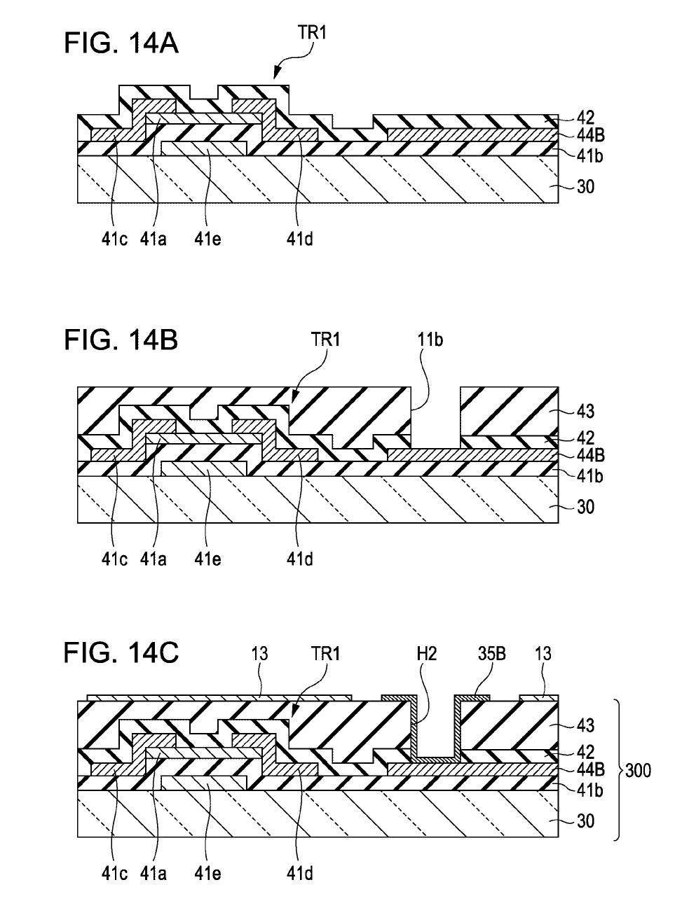

Next, as illustrated in FIG. 14A, the interlayer insulating film 42 made of silicon oxide and having a thickness of 300 nm is formed so as to cover the source electrode 41c, the drain electrode 41d, and the connecting electrode 44A (44B) by plasma CVD.

Next, as illustrated in FIG. 14B, photosensitive acryl having a thickness of 1 μm is applied onto the interlayer insulating film 42 using spin coating, so that the interlayer insulating film 43 is formed. Then, the interlayer insulating film 43 is partially exposed and developed, so that openings are formed, and further, with the interlayer insulating film 43 used as a mask, part of the interlayer insulating film 42 is removed by dry etching. Thus, a plurality of through-holes 11b that each expose part of the top of the drain electrode 41d (the connecting electrode 44A (44B)) are formed.

Next, as illustrated in FIG. 14C, an ITO film having a thickness of 50 nm is formed over the entire surface of the interlayer insulating film 43 by sputtering and is patterned by photoetching, so that a plurality of pixel electrodes 35B (35A) and the control electrode 13 are formed. The pixel electrodes 35B (35A) and the control electrode 13 are formed in the same process. The pixel electrode 35A is connected to the connecting electrode 44A via the contact hole H1, and the pixel electrode 35B is connected to the connecting electrode 44B via the contact hole H2.

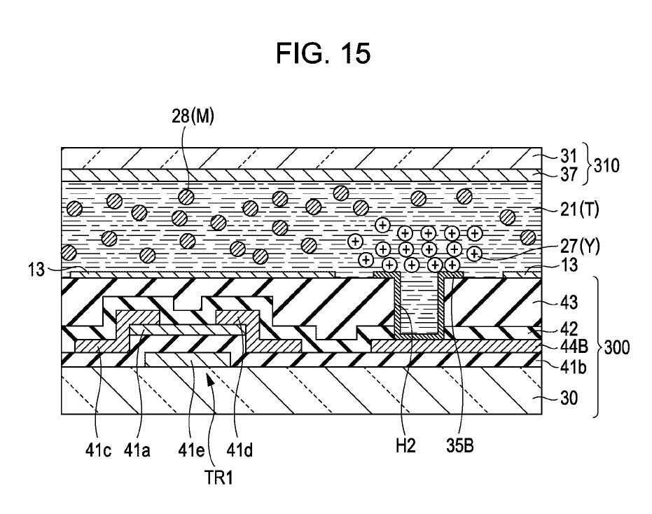

Next, as illustrated in FIG. 15, the sealing member 16 (not illustrated) made of ultraviolet-curable epoxy resin having a height of 40 μm is formed on the outermost surface (interlayer insulating film 43) of the element substrate 300, and an electrophoretic material is applied in an area surrounded by the sealing member 16, so that the electrophoretic layer 32 is formed. Then, the counter substrate 310 is bonded onto the element substrate 300. In this way, the electrophoretic display device of this embodiment is completed.

According to the method of manufacturing an electrophoretic display device of this embodiment, the control electrodes 13 can be formed at the same time as pluralities of pixel electrodes 35A and 35B. Therefore, a formation process for the control electrodes 13 need not be separately provided. This facilitates manufacturing of an electrophoretic display device.

### Modifications

Hererinbelow, modifications of the control electrode will be described.

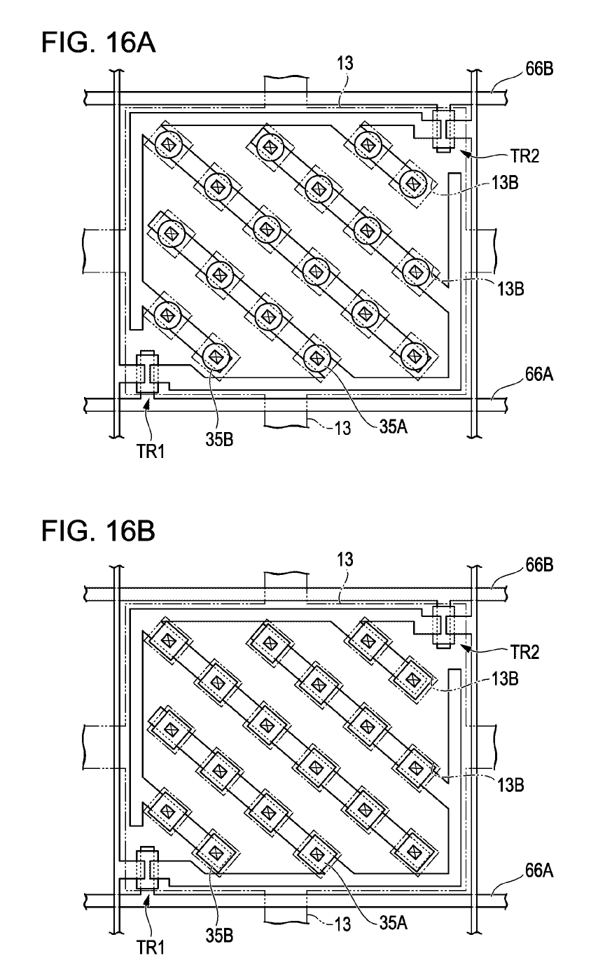

In the above-described electrophoretic display device 100 of the first embodiment, the shape in plan view of the opening 13A of the control electrode 13 is circular. However, the opening of the control electrode 13 is not limited to this, and may be, for example, a rectangular opening 13B as illustrated in FIG. 16A. An elliptical shape and a triangular shape other than this shape may be employed. In the case of the opening 13B being rectangular in plan view, it is preferable, as illustrated in FIG. 16B, that the pixel electrodes 35A and 35B be also all rectangular in plan view, and the orientations of the pixel electrode 35A and 35B be coincident with that of the opening 13B such that the four sides of the pixel electrodes 35A and 35B face the four sides of the openings 13B. This allows the connecting electrodes 44A and 44B (the drain electrodes 41d) to be covered as much as possible with the control electrode 13. That is, shielding above the drain electrode 41d is provided by the control electrode 13, which prevents the voltage of the data line 68 from being directly applied to the electrophoretic material to affect display. Thus, excellent display can be obtained in a stable manner.

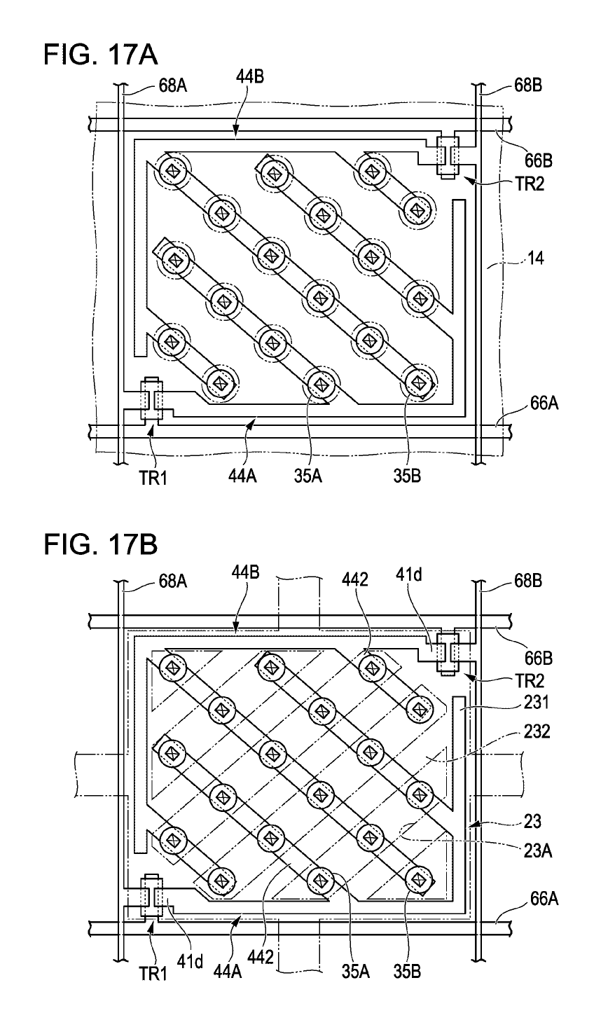

In the above-described first embodiment, the control electrode 13 is partially thinned in the areas where the pixels 40 are connected to each other with the control electrode 13 (at the intersection of the control electrode 13 and each of the scanning line 66A, the scanning line 66B, the data line 68A, and the data line 68B). However, a control electrode may be formed in such a solid manner as to be continuous over all pixels on the first substrate 30, as a control electrode 14 illustrated in FIG. 17A. In the control electrode 14, a plurality of openings 14A partially exposing areas where the control electrode 14 overlaps the pixel electrodes 35A and 35B, in plan view, and peripheral areas thereof are formed such that the number of the openings 14A corresponds to the number of the pixel electrodes 35A and 35B.

With this structure, the tops of the scanning lines 66A and 66B and the data lines 68A and 68B in the display region are covered with the control electrode 14. Accordingly, electric fields of the scanning lines 66A and 66B and the data lines 68A and 68B to the electrophoretic material can be nearly completely shielded by the control electrode 14. This makes it possible to solve problems such as a crosstalk.

Also, as illustrated in FIG. 17B, a control electrode 23 including openings having slit shapes may be used. The control electrode 23 includes a frame portion 231 along the pixel region and a plurality of branch portions 232 extending in directions diagonal to directions along the scanning lines 66A and 66B and the data lines 68A and 68B, and slit-shaped openings 23A are formed between the branch portions 232. The branch portions 232 are provided so as to intersect the branch portions 442 of the connecting electrodes 44A and 44B having a comb shape in plan view.

The control electrode 23 is formed so as to cover the tops of the select transistors TR1 and TR2 and most of the drain electrodes 41d (the connecting electrodes 44A and 44B) of the transistors TR1 and TR2, except for portions of the drain electrodes 41d facing the openings 23A.

Effects similar to those of the foregoing control electrode can be obtained by providing the control electrode 23 as described above.

### Second Embodiment

Next, an electrophoretic display device of a second embodiment will be described.

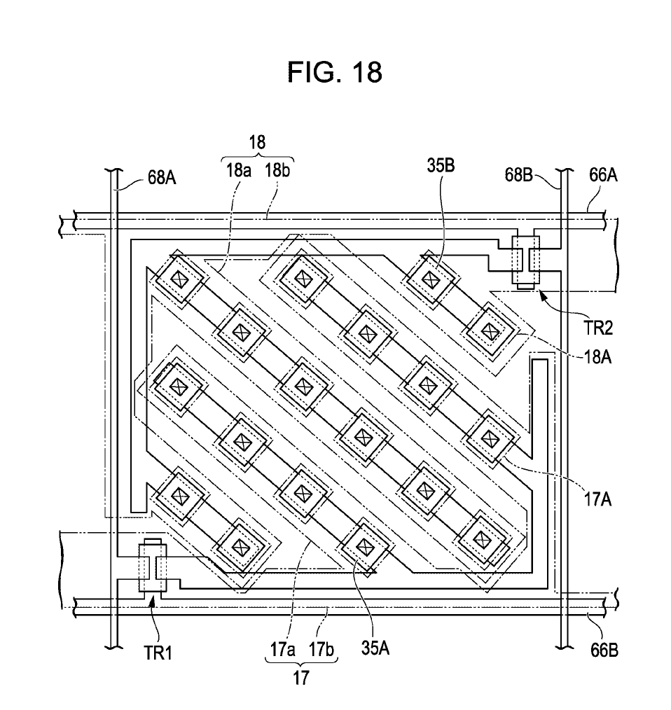

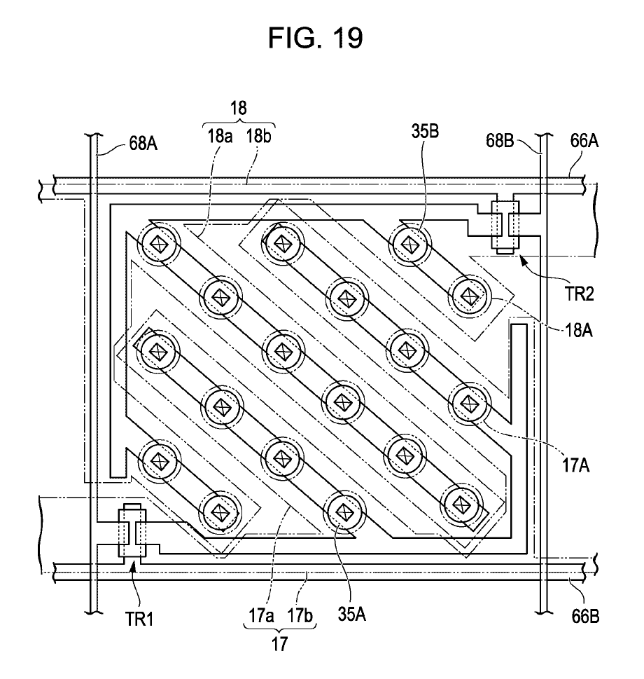

FIG. 18 is a plan view illustrating a pixel structure of an electrophoretic display device of the second embodiment. FIG. 19 is a plan view illustrating a modification of the control electrode in the second embodiment.

As illustrated in FIG. 18, the select transistors TR1 and TR2, the connecting electrodes 44A and 44B, the pixel electrodes 35A and 35B, and a control electrode 17 (a first control electrode) and a control electrode 18 (a second control electrode) are provided in each pixel 40 on the first substrate 30.

In the foregoing embodiment, one control electrode is provided in each pixel 40. However, in this embodiment, two control electrodes 17 and 18 are provided in each pixel 40. The control electrodes 17 and 18 are provided for the select transistors TR1, the connecting electrodes 44A, and the pixel electrodes 35A, the select transistor TR2, the connecting electrode 44B, and the pixel electrodes 35B. The two control electrodes 17 and 18 are provided so as to be parallel to the scanning lines 66, and part thereof covers the scanning lines 66. In the outside of the display section 5, voltages are applied to the control electrodes 17 and 18.

The control electrodes 17 and 18 each have a comb shape in plan view, and their respective control branch portions 17a and 18a extend in such a manner as to overlap branch portions 442 of the connecting electrodes 44A and 44B in plan view, respectively. Common portions 17b and 18b with which pluralities of control branch portions 17a and 18a are connected to one another are formed so as to cover the tops of the select transistors TR1 and TR2, respectively. Thus, the following effect is obtained. That is, shielding of portions above the drain electrodes 41d (the connecting electrodes 44A and 44B) is provided by the control electrodes 17 and 18.

In the control branch portions 17a and 18a, pluralities of openings 17A and 18A corresponding to the pixel electrodes 35A and 35B are formed for exposing the pixel electrodes 35A and 35B. In the drawing, the shapes of the openings 17A and 18A are rectangular in plan view. However, as illustrated in FIG. 19, the openings 17A and 18A may have circular shapes in plan view in accordance with the shapes of the pixel electrodes 35A and 35B.

In this embodiment, the two independent control electrodes 17 and 18 are provided for the two pixel electrodes 35A and 35B. In the above-described structure of the first embodiment, one control electrode is provided, and therefore two frames are needed for causing the positively charged particles 27 and the negatively charged particles 26 to move to the side of the counter electrode 37. In contrast, with the structure of this embodiment, the control electrodes 17 and 18 can be driven independently of each other, and therefore both the positively charged particles and the negatively charged particles can be caused to move at the same time in one operation within one frame.

Specifically, a positive voltage is applied to a control electrode corresponding to a pixel electrode (surrounding the pixel electrode) to which a positive voltage is applied, and a negative voltage is applied to a control electrode corresponding to a pixel electrode to which a negative voltage is applied. By such the control electrodes 17 and 18, the positively charged particles 27 and the negatively charged particles 26 are both repelled when caused to move at the same time, and, as a result, the charged particles 26 and 27 smoothly move to the side of the counter electrode 37.

In FIGS. 18 and 19, the control electrodes 17 and 18 are provided so as to be parallel to the scanning lines 66A and 66B. However, the control electrodes 17 and 18 may be provided so as to be parallel to the data lines 68A and 68B. At that point, part or more of the control electrodes 17 and 18 may be provided so as to cover the data lines 68A and 68B.

### Third Embodiment

Next, an electrophoretic display device of a third embodiment will be described.

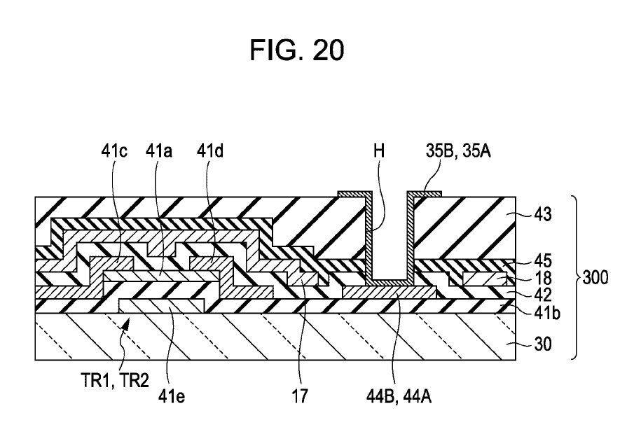

FIG. 20 is a partial sectional view illustrating a schematic structure of an electrophoretic display device of the third embodiment.

As illustrated in FIG. 20, the electrophoretic display device includes, on the first substrate 30, the select transistor TR1, which includes the gate electrode 41e, the gate insulating film 41b, the semiconductor layer 41a, the source electrode 41c, and the drain electrode 41d; and the connecting electrode 44B (44A), and the electrophoretic display device further includes the interlayer insulating film 42 formed above the first substrate 30 in such a manner as to cover these elements, the control electrode 18 (17) formed on the interlayer insulating film 42 and made of aluminum having a thickness of 300 nm, an interlayer insulating film 45 made of silicon nitride having a thickness of 300 nm and formed in such a manner as to cover the control electrode 18 (17), and the interlayer insulating film 43 formed on the interlayer insulating film 45. The pixel electrode 35B (35A) is connected to the connecting electrode 44B (44A) via a contact hole H formed through the three interlayer insulating films 42, 45, and 43.

In the embodiments described above, the control electrodes 17 and 18 are provided in the same layer as the pixel electrodes 35A and 35B, and are formed using the same material in the same process as the pixel electrodes 35A and 35B. However, in this embodiment, the control electrodes 17 and 18 are disposed in a layer above the drain electrode 41d (the connecting electrodes 44A and 44B) of the select transistor TR1 (TR2) and below the pixel electrode 35B (35A).

As shown in the second embodiment, in cases where each of the two control electrodes 18 (17) is formed in the same layer as the pixel electrode 35B (35A), problems arise as follows.

A first problem is that the wiring resistance of the control electrode 18 (17) increases.

ITO is typically used for the pixel electrode 35B (35A). However, the specific electrical resistance of ITO is high, and therefore the potential is difficult to be fixed when the control electrode is formed in a thin wiring fashion as described in the second embodiment. This is a cause of a crosstalk.

A second problem is a decrease of yield. The distance between the pixel electrode 35B (35A) and each of the two control electrode 18 (17) is short, and the pixel electrode 35B (35A) and the control electrode 18 (17) are present on the front surface of the display area (the outermost layer of the first substrate 30), and therefore a short-circuit defect easily occurs.

To address these problems, in this embodiment, the interlayer insulating film 45 is newly provided, and the control electrode 18 (17) is disposed between the drain electrode 41d (the connecting electrode 44B (44A)) and the pixel electrode 35B (35A). The control electrode 18 (17) is made of aluminum having a thickness of 300 nm, and is formed in the same way as the source electrode 41c and the drain electrode 41d. Also, the interlayer insulating film 45 is a silicon nitride film having a thickness of 300 nm, and is formed in the same way as the interlayer insulating film 42.

Here, a layer in which the control electrode 18 (17) is disposed is not limited to the layer mentioned above if the layer is between the drain electrode 41d and the pixel electrode 35B (35A).

In addition, with the structure of this embodiment, a conductive material other than ITO can be used as a material for forming the control electrode 18 (17).

As such, with the structure of sandwiching an insulating film between the layer of the control electrodes 17 and 18 and the layer of the pixel electrode 35B (35A), it is possible to prevent a short-circuit defect between the control electrode 18 (17) and the pixel electrode 35B (35A).

It is to be noted that the pixel electrode 35B (35A) is desirably the top layer of the first substrate 30 in order to control the charged particles 26 and 27.

While preferred embodiments according to the invention have been described with reference to the accompanying drawings, it is to be understood that the invention is not limited to such embodiments. It is apparent that any person skilled in the art can easily conceive various changes and modifications within the scope of technical ideas in the description of claims, and it is to be understood such changes and modifications fall within the technical scope of the invention.

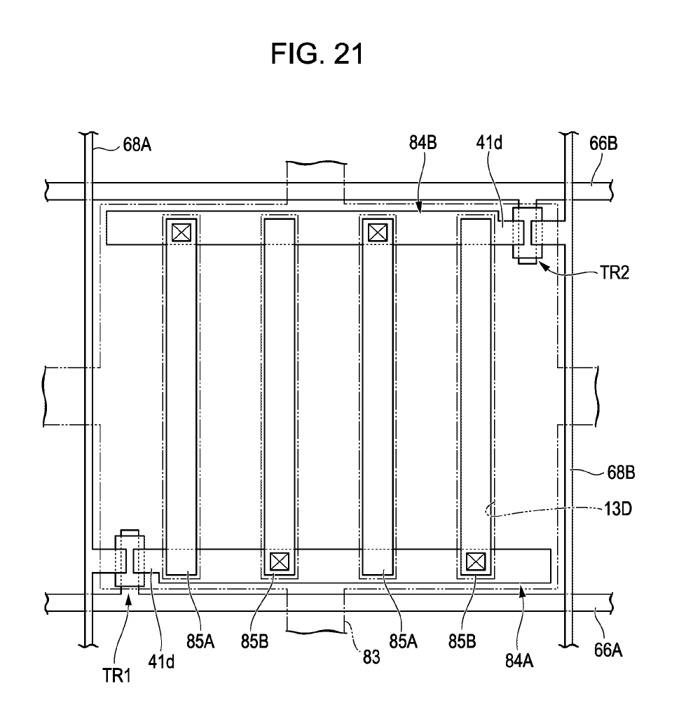

For example, as illustrated in FIG. 21, pluralities of pixel electrodes 85A and 85B may be arranged in stripes in one pixel (the pixel 40). The pixel electrodes 85A and 85B, which are rectangular in plan view, extend in a uniform direction, and are alternately disposed at certain intervals in the short side direction. Here, the pixel electrodes 85A and 85B are disposed at regular intervals. Connecting electrodes 84A and 84B that connect the plurality of pixel electrodes 85A with one another and the plurality of pixel electrodes 85B with one another are disposed closer to the first substrate 30 than the pixel electrodes 85A and 85B. The connecting electrodes 84A and 84B have rectangular shapes in plan view extending perpendicular to the direction along the pixel electrodes 85A and 85B.

In a control electrode 83 in such a structure, a plurality of openings 13D that are rectangular in plan view and each have an opening area larger than an area of forming the pixel electrode 85A or 85B are formed in accordance with the number of pixel electrodes 85A and 85B. It is preferable that the control electrode 83 be formed in a lower layer (closer to the first substrate 30) than the pixel electrodes 85A and 85B in order to avoid a short-circuit defect between the control electrode 83 and the pixel electrodes 85A and 85B.

It is to be noted that the control electrode 83 and the pixel electrodes 85A and 85B may be formed in the same layer.

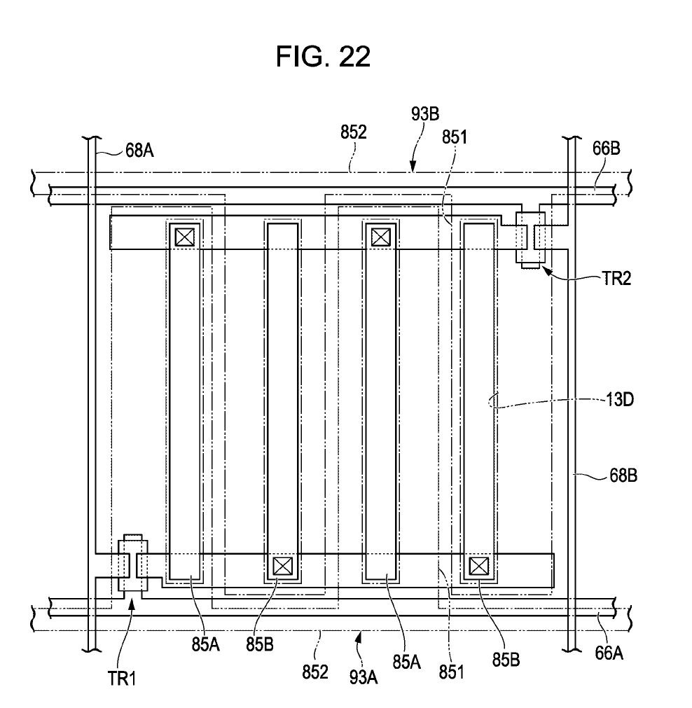

Alternatively, as illustrated in FIG. 22, two control electrodes 93A and 93B arranged in stripes in one pixel (the pixel 40) may be provided. The control electrodes 93A and 93B include a plurality of control branch portions 851 extend along the direction of the pixel electrodes 85A and 85B, and connection portions 852 connecting the plurality of control branch portions 851 to one another. Each control branch portion 851 is provided with the opening 13D rectangular in plan view corresponding to the respective pixel electrode 85A or 85B.

As such, the pixel electrodes 85A and 85B that are rectangular in plan view are provided. The areas of the pixel electrodes 85A and 85B are larger than those of circular pixel electrodes described in the above embodiment, and therefore the pixel electrodes 85A and 85B can cause the charged particles to gather efficiently.

The combination of colors of a dispersion medium and particles in the electrophoretic layer 32 may be changed.

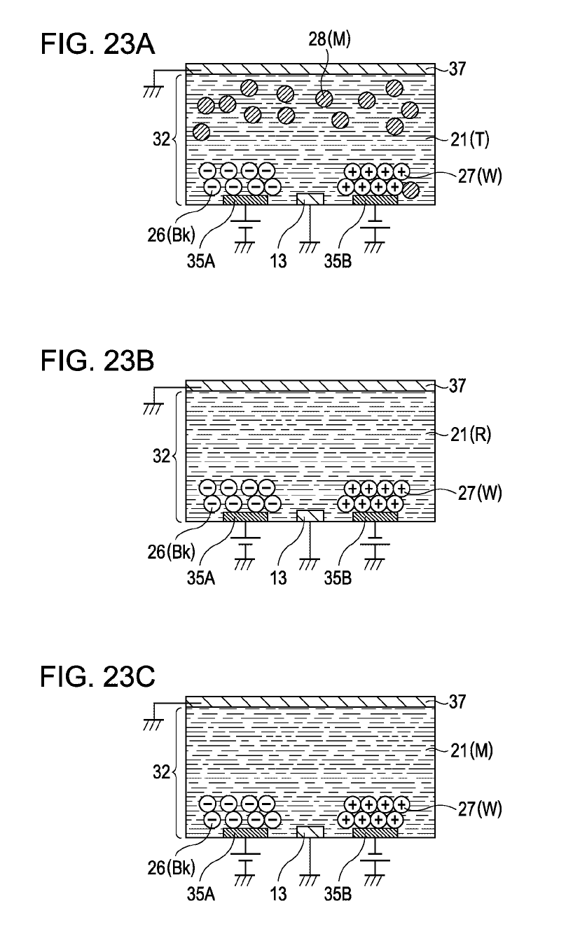

For example, in FIG. 23A, magenta particles are used in place of red particles. In the transparent colorless dispersion medium 21(T), the negatively charged particles 26(Bk) of black, the positively charged particles 27(W) of white, and the uncharged particles 28(M) of magenta are held. In this case, the positive voltage VH is applied to the pixel electrode 35A, and the negative voltage VL is applied to the pixel electrode 35B, which enables light magenta display.

It is to be noted that charged particles of cyan and yellow are further used, and subpixels containing charged particles of any of cyan, magenta, and yellow are provided, so that the hue can be controlled, which enables color display.

In FIG. 23B, the negatively charged particles 26(Bk) of black and the positively charged particles 27(W) of white are held in the dispersion medium 21(R) of red. In this case, the brightness and saturation of red can be controlled by applying predetermined voltages to the pixel electrode 35A and the pixel electrode 35B.

In FIG. 23C, the negatively charged particles 26(Bk) of black and the positively charged particles 27(W) of white are held in the dispersion medium 21(M) of magenta. In this case, like the case of FIG. 23B, the brightness and saturation of magenta can be controlled.

It is to be noted that while the magenta color can be displayed in the case of FIG. 23A, a color darker than the magenta color can be displayed in the case of FIG. 23C.

Cyan, magenta, and yellow (CMY), red, green, and blue (RGB), or the like may be used as colors of the charged particles, the uncharged particles, and the dispersion medium.

In the cases of FIGS. 23B and 23C, color display can be performed using subpixels.

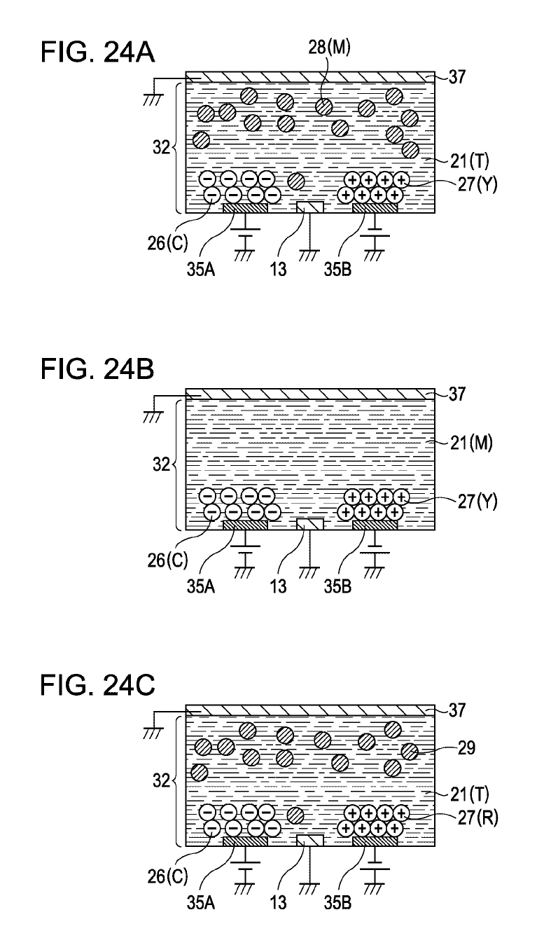

In FIG. 24A, negatively charged particles 26(C) of cyan, positively charged particles 27(Y) yellow, and the uncharged particles 28(M) of magenta are held in the transparent colorless dispersion medium 21(T). Also, in this case, display of light color can be performed by applying predetermined voltages to the pixel electrode 35A and the pixel electrode 35B using a driving method according to an embodiment of the invention. In this case, not only the brightness and the saturation but also the hue are controlled using the distribution of charged particles. For the control of the brightness, saturation, and hue, the area of distribution of charged particles is used, and color mixture performed by mixing particles is also used. For example, in an area where yellow particles exist near cyan particles, light reflected from both the particles is green as transmitted light common to both the particles. As a result, only green light is reflected on the observation side. As such, color mixture is obtained by reflection and scattering of light by using particles of different colors.

Such color mixture of charged particles is a state in which the positively charged particles 27(W) of white, the negatively charged particles 26(Bk) of black, and the uncharged particles 28(M) of magenta illustrated in FIG. 23A are replaced with particles of any of cyan, magenta, and yellow. Color mixture can also be made by mixing uncharged particles and charged particles.

This way does not use a subpixel, and therefore also does not use a separating measure for subpixels, such as partitions.

In FIG. 24B, the dispersion medium 21(M) of magenta is used in place of the transparent colorless dispersion medium 21(T) in FIG. 24A. The uncharged particles of magenta are not used. In this case, the positive voltage VH is applied to the pixel electrode 35A, and the negative voltage VL is applied to the pixel electrode 35B, so that dark magenta display can be performed.

In FIG. 24(c), the negatively charged particles 26(C) of cyan, the positively charged particles 27(R) of red, and transparent particles 29 as uncharged particles are held in the transparent colorless dispersion medium 21(T). In this case, the positive voltage VH is applied to the pixel electrode 35A, and the negative voltage VL is applied to the pixel electrode 35B, so that white display can be performed. Light entering from the counter electrode 37 undergoes irregular reflection that is given by the transparent particles 29 floating in the dispersion medium 21(T), and therefore the light is emitted from the side of the display surface (the counter electrode 37). Thus, light white display is obtained.

As such, the mixture of the transparent particles 29 enables light to be effectively scattered in the dispersion medium 21. This can improve display luminance. As a result, high contrast display can be achieved.

Here, an example of the combination of red with cyan, which is the complementary color of red, is presented. Controlling the magnitudes of voltages to be applied to the pixel electrode 35A and the pixel electrode 35B causes some negatively charged particles 26(C) of cyan and some positively charged particles 27(R) of red to move to the side of the counter electrode 37, so that the negatively charged particles 26(C) of cyan and the positively charged particles 27(R) of red are each three-dimensionally mixed (distributed). Thus, black display can be performed.

It is to be noted that other combinations of complementary colors, that is, the combination of blue and yellow and the combination of green and magenta can be used. Subpixels of such a combination may be aligned and used as one pixel, so that color display is performed.

As in an embodiment of the invention, combining a colored dispersion medium with colored particles in an arbitrary manner makes it possible to perform full color display.

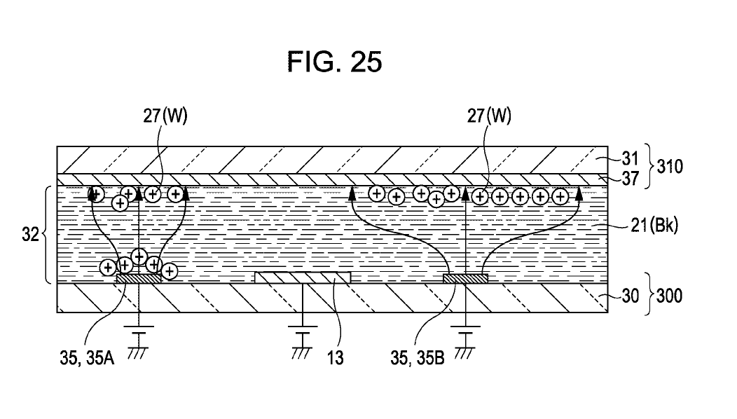

As illustrated in FIG. 25, an electrophoretic display device of one-particle system can be employed.

In the electrophoretic layer 32 illustrated in FIG. 25, the positively charged particles 27(W) of white are held in the dispersion medium 21(Bk) of black. On the first substrate 30, the plurality of pixel electrodes 35 and the control electrode 13 around the pixel electrodes 35 are formed. Here, when a positive voltage is applied to the pixel electrodes 35, the positively charged particles 27(W) move to the side of the counter electrode 37 by an electric field due to a potential difference (voltage) between a potential corresponding to the applied voltage and the ground potential of the counter electrode 37. At the same time, a positive voltage is also applied to the control electrode 13, which ensures that the positively charged particles 27(W) move to the side of the counter electrode 37 without being drawn toward the control electrode 13.

For example, when a medium positive voltage Vh (Vh <VH) is applied to the pixel electrode 35A (left side in the drawing), the applied voltage is not very large, and therefore the positively charged particles 27(W) are not widely distributed on the side of the counter electrode 37. The positively charged particles 27(W) are concentrated in a narrow range. This allows the realization of a spot distribution. The number of the moving particles also decreases. Thus, white display in a small area can be expressed here.

In contrast, when a large positive voltage VH (the maximum positive value) is applied to the pixel electrode 35B illustrated on the right side in the drawing, a potential difference (voltage) between the pixel electrode 35B and the counter electrode 37 is larger than that in the above-mentioned case, and therefore a larger electric field is generated between the pixel electrode 35B and the counter electrode 37. For this reason, the positively charged particles 27(W) move to the side of the second substrate 31 from the side of the pixel electrode 35A to which the positive voltage Vh is applied. Typically, almost all the positively charged particles 27(W) move. With the increase in electric field, a diagonal electric field from the pixel electrode 35B also increases. The increased diagonal electric field causes the positively charged particles 27(W) to be dispersed in a wider range in a direction parallel to the second substrate 31. As a result, the distribution range of the positively charged particles 27(W) expands in plan view. Thus, on the pixel electrode 35B, white display can be expressed in an area larger than that on the pixel electrode 35A.

It is to be noted that in the case of not moving the positively charged particles 27(W) to the counter electrode 37, that is, in the case where a negative voltage is applied to each pixel electrode 35, so that all the particles 27(W) accumulate on the pixel electrodes 35, the black color of the dispersion medium 21(B) is visually recognizable from the side of the second substrate 31. Therefore, the entire pixel is displayed in black.

In this way, the electrophoretic display device of one-particle system can also be handled. In this case, a voltage for repelling charged particles is applied to the control electrode 13, which makes it possible to cause particles to move without being retained in an area without the pixel electrode 35 on the first substrate 30. Thus, stable display with good visibility can be performed.

Also, the numbers and the distribution states (distribution areas) of the positively charged particles 27(W) that are to arrive at the counter electrode 37 are controlled. This makes it possible to control black display, white display, or display of an intermediate gray-scale from black to white. Further, the plurality of island-shaped pixel electrodes 35 are provided in one pixel, which makes it possible to give greater control over display.

In FIG. 25, the positively charged particles 27(W) of white and the dispersion medium 21(Bk) of black are used. However, the charged polarity and color of particles and the color of the dispersion medium are not limited, and other combinations may be used.

In the one-particle system of FIG. 25, the two pixel electrodes 35A and 35B are used, and the transistors TR1 and TR2 are connected to each pixel electrode as described in the first embodiment, which is not illustrated. The structure in plan view is similar to that of FIG. 6. The driving method is basically the same as that described with reference to FIGS. 11A and 11B and FIGS. 12A and 12B. Here, as illustrated in FIG. 25, voltages can be applied to the two pixel electrodes 35A and 35B at the same time. The operation of FIG. 11B and the operation of FIG. 12A are performed at one time. At the time, a positive voltage is applied to the control electrode 13. However, sequential voltage application as illustrated in FIGS. 11A and 11B is also possible. Particles of different polarities do not exist, and therefore only the first pre-set operation corresponding to FIG. 11A is performed, and the second pre-set operation is not performed.

In the one-particle system, one pixel can be made of one transistor TR1. In this case, the transistor TR2 and the electrodes connected thereto of FIG. 6 are removed in the structure. The driving method is basically the same as that described with reference to FIGS. 11A and 11B and FIGS. 12A and 12B. The pixel electrode 35B does not exist, and therefore the operation of FIGS. 12A and 12B is omitted. The polarity of the particles 26(Bk) of FIGS. 11A and 11B is changed from the negative polarity to the positive polarity, and the two operations of FIGS. 11A and 11B are alternately repeated.

In the above case, the polarity of the charged particles need not be limited to being positive.

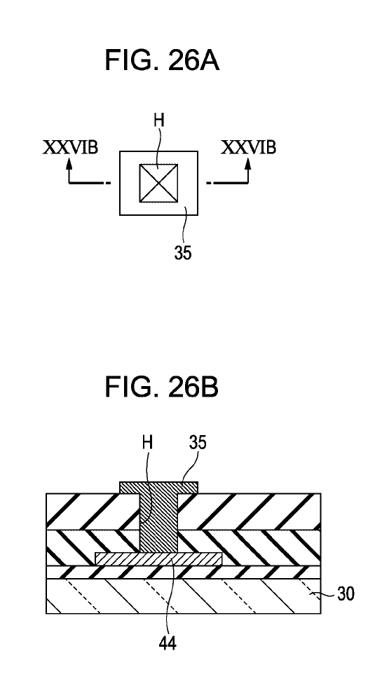

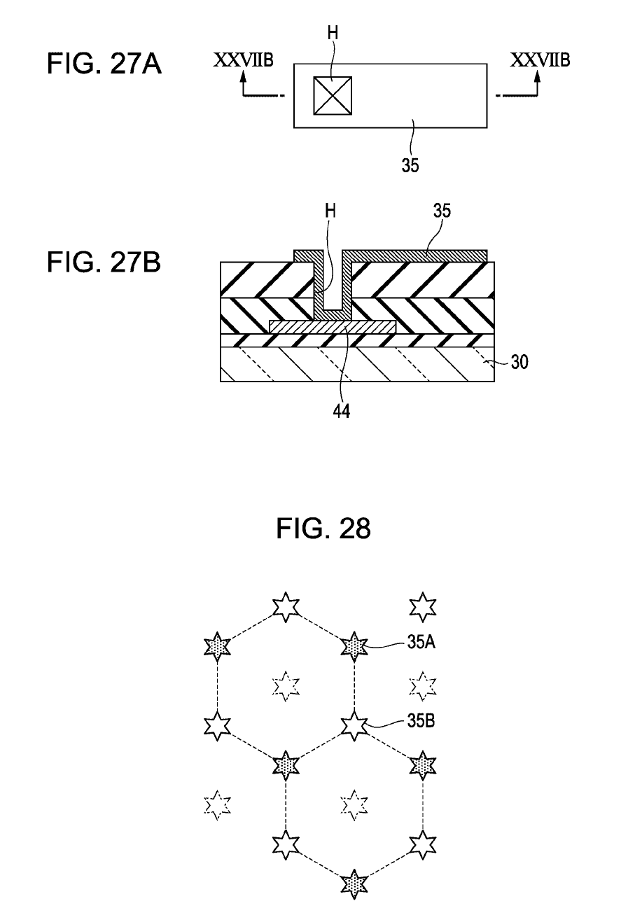

The shape in plan view of the pixel electrode may be a rectangle (square) or an oblong other than a circle. As illustrated in FIGS. 26A and 26B and FIGS. 27A and 27B, each pixel electrode 35 may have another shape if each pixel electrode 35 is securely connected via the contact hole H to the connecting electrode 44 in a lower layer. For example, an approximately star shape in plan view as illustrated in FIG. 28 may be used. With the shape of partially protruding toward the adjacent pixel electrode 35A or 35B, an electric field is more likely to extend toward the adjacent pixel electrode 35A or 35B. Therefore, an effect of facilitating color mixture is obtained.

Here, the arrangement of the pixel electrodes 35A and 35B is hexagonal in plan view, and therefore the pixel electrodes 35A and 35B each have a shape with six protrusions. In the case where the arrangement of the pixel electrodes 35A and 35B is triangular in plan view, the shape with three protrusions results in the same effect as the shape with six protrusions. As such, various shapes are applicable as the shape of the pixel electrode.

Alternatively, as illustrated in FIG. 26B, a shape in which the inside of the contact hole H is filled with the pixel electrode 35 may be used to prevent particles from entering into the contact hole.

In the foregoing embodiments, a liquid dispersion medium is used. However, the dispersion medium may be gas.

As the particles contained in the dispersion medium 21, particles having such a structure that the center of the particle is hollow may be used. Such a structure allows light to be scattered from the surface of a particle, and, in addition, allows light to be scattered from a wall surface forming the hollow inside the particle. This enables improvement of the scattering efficiency of light. Thus, color development of white and other colors can be improved.

### Electronic Apparatuses

A description will next be given of cases in which the electrophoretic display device of one of the foregoing embodiments is applied to an electronic apparatus.

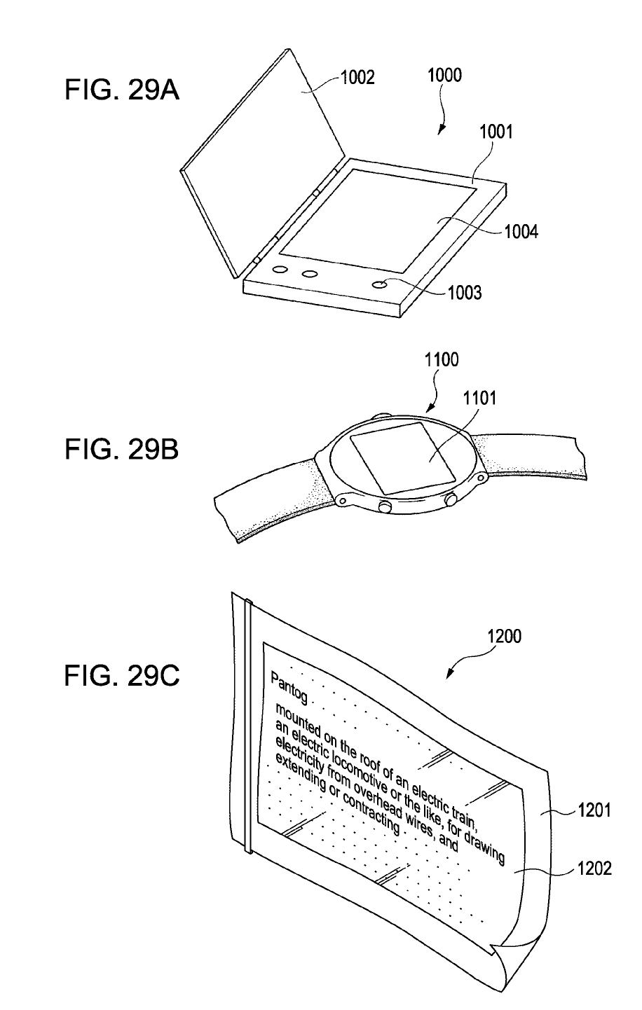

FIGS. 29A through 29C are perspective views illustrating specific examples of an electronic apparatus to which the electrophoretic display device of one embodiment of the invention is applied.

FIG. 29A is a perspective view illustrating an electronic book as an example of the electronic apparatus. An electronic book 1000 includes a frame 1001 shaped like a book, a cover 1002 provided so as to be rotatable (openable) around the frame 1001, an operation section 1003, and a display section 1004 made of an electrophoretic display device of one embodiment of the invention.

FIG. 29B is a perspective view illustrating a wristwatch as an example of the electronic apparatus. A wristwatch 1100 includes a display section 1101 made of an electrophoretic display device of one embodiment of the invention.

FIG. 29C is a perspective view illustrating electronic paper as an example of the electronic apparatus. Electronic paper 1200 includes a body section 1201 made of rewritable sheets having texture and bendability similar to those of existing paper, and a display section 1202 made of an electrophoretic display device of one embodiment of the invention.

For example, applications of repeatedly writing characters on a white background are assumed for electronic books, electronic paper, and the like, and therefore a residual image at the time of erasing characters and a temporal residual image need to be eliminated.

It is to be noted that the range of an electronic apparatus to which an electrophoretic display device of one embodiment of the invention is applicable is not limited to those mentioned above, and broadly includes apparatuses utilizing a visual change in tone that is associated with movement of charged particles.

According to the electronic book 1000, the wrist watch 1100, and the electronic paper 1200 described above, an electrophoretic display device according to one embodiment of the invention is employed, and therefore electronic apparatuses including color display units are implemented.

It is to be noted that the above-mentioned electronic apparatuses are illustrative of an electronic apparatus according to one embodiment of the invention, and do not limit the technical scope of the invention. For example, an electrophoretic display device according to one embodiment of the invention can be preferably used for a display section of an electronic apparatus such as a cellular phone or a portable audio unit.

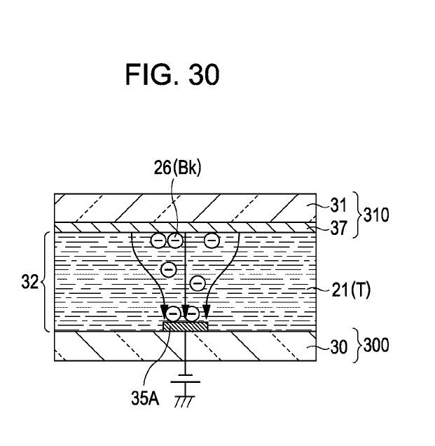

FIG. 30 illustrates a distribution state of charged particles during voltage application.

In FIG. 2 referred to above, some negatively charged particles 26(Bk) move from the pixel electrode 35A toward the side of the counter electrode 37, and a large majority of the moved charged particles arrive at the counter electrode 37 and positioned in the vicinity thereof. In actuality, however, as illustrated in FIG. 30, when a predetermined negative voltage is applied to the pixel electrode 35A, not all the charged particles leaving the pixel electrode 35A arrive at the counter electrode 37. Some negatively charged particles 26(Bk) are located (float) in the dispersion medium 21(T) between the pixel electrode 35A and the counter electrode 37. Also, in this case, gray scale and color mixture are expressed by the distribution area of effective particles, including the negatively charged particles 26(Bk) of black located in the transparent dispersion medium 21(T), as seen from the side of the counter electrode 37.

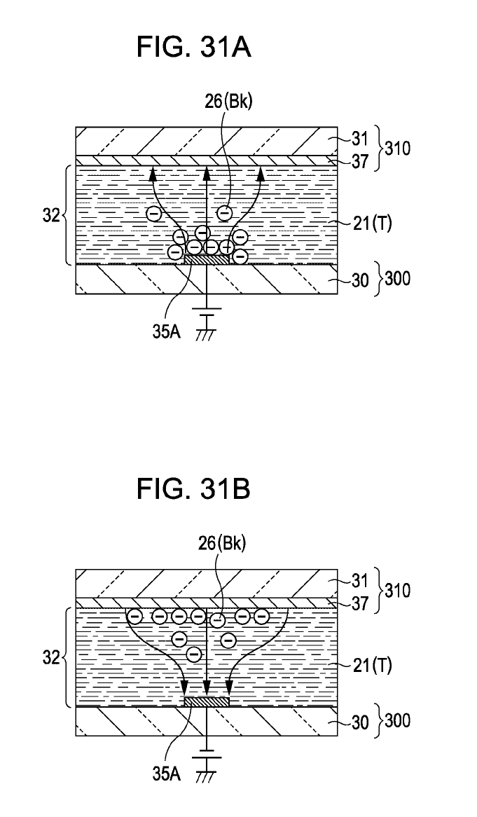

FIGS. 31A and 31B illustrate distribution states of charged particles during voltage application. FIG. 31A illustrates a state during application of a positive voltage, and FIG. 31B illustrates a state during application of a negative voltage.

To cause all the charged particles to move to the vicinities of the pixel electrodes 35 or to the vicinity of the counter electrode 37, voltages need to be applied for some long time or large voltages need to be applied.

As illustrated in FIG. 31A, in the case where the duration of application of the positive voltage VH to the pixel electrode 35A is short, not all the negatively charged particles 26(Bk) have moved to the side of the pixel electrodes 35, and, as a result, some negatively charged particles 26(Bk) are located in the dispersion medium 21(T). As illustrated in FIG. 31B, in the case where the duration of application of the negative voltage VL to the pixel electrode 35A is short, not all the negatively charged particles 26(Bk) have moved to the side of counter electrode 37, and, as a result, some negatively charged particles 26(Bk) are located in the dispersion medium 21(T).

Also, in these cases, gray scale and color mixture are expressed by the distribution area of effective particles, including the negatively charged particles 26(Bk) in the transparent dispersion medium 21(T), as seen from the side of the counter electrode 37.

As described above, even when some charged particles are located in the dispersion medium, the operation of the electrophoretic display device can be performed. This applies to cases where two types of pixel electrodes that are driven independently of each other are used in one pixel.

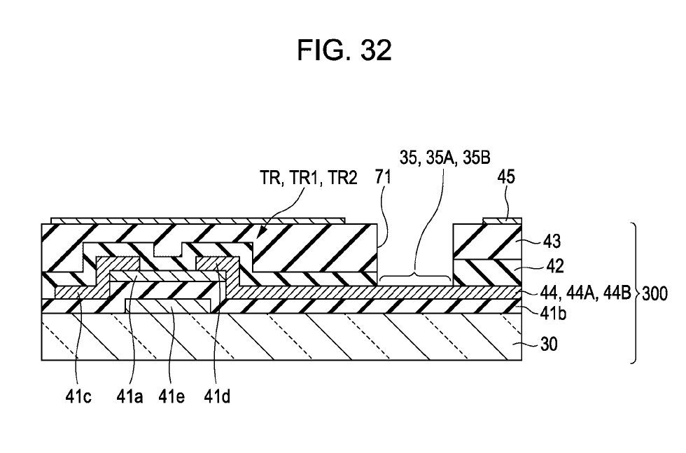

FIG. 32 is a sectional view illustrating a modification of the layout in one pixel (a modification of the structure illustrated in FIG. 7).

As illustrated in FIG. 32, here, the structure is such that the island-shaped pixel electrodes 35 are not used in the top layer of the element substrate 300, and all other points are the same as those of the foregoing embodiments.

In this example, part of the connecting electrode 44 (44A or 44B) is exposed in a through-hole 71 formed through both the interlayer insulating films 42 and 43 laminated on the first substrate 30. A large number of through-holes 71 for partially exposing the connecting electrode 44 are formed in the interlayer insulating films 42 and 43. Specifically, the large number of through-holes 71 are formed at certain intervals so as to overlap the connecting electrodes 44 (44A and 44B) connected to the drain electrodes 41d of the transistors TR (TR1 and TR2) in accordance with the shapes of the connecting electrodes 44 (44A and 44B), which results in a structure in which the connecting electrode 44 (44A or 44B) is partially exposed through each through-hole 71. Part of the connecting electrodes 44 (44A and 44B) exposed in the large number of through-holes 71 have functions similar to those of the island-shaped pixel electrodes 35 (35A and 35B) used in the foregoing embodiments and are in contact with the electrophoretic layer 32. Even with such a structure, the operation as an electrophoretic display device is the same as the foregoing embodiments.

In such a structure, for example, when the negative voltage VL is applied to the connecting electrode 44, the positively charged particles 27(W) as illustrated in FIG. 2 are drawn by the connecting electrode 44 exposed in the through-hole 71 to enter into the through-hole 71. Therefore, when the voltage application to the connecting electrode 44 is stopped, a large number of positively charged particles 27(W) are held in the through-hole 71. This can prevent the particles from spreading when operation shifts from a voltage application state to a state where no voltage is applied.

Here, the connecting electrode 44 need not be necessarily exposed from the insulating film. For example, in FIG. 32, the structure is such that the through-holes pass through both the interlayer insulating films 42 and 43 to expose the connecting electrode 44. However, the structure may be such that the through-holes pass through the interlayer insulating film 43 only, and the interlayer insulating film 42 remains intact. With the latter structure, the voltage drop in the interlayer insulating film 42 in an area where the interlayer insulating film 43 is removed is less than that in the other area where the interlayer insulating film 43 is present, which makes it possible to apply a voltage to the electro-optical material more effectively. Accordingly, part of the connecting electrode 44 existing directly under the through-hole formed only in the interlayer insulating film 42 actually functions as a pixel electrode.

In the case of not providing the pixel electrodes 35 as a separate layer as illustrated in FIG. 32, it is preferable from the viewpoint of reliability that the material of the surface of the connecting electrode 44 at least in the through-hole 71 be the same as the material for the counter electrode 37.

It is to be noted that the materials of which the above-mentioned pixel electrodes 35A and 35B and the control electrode 45 are made are not limited to transparent electrodes. Other inorganic and organic materials may be used. Further, the pixel electrode may have reflecting properties.

The above description has been given of a display device using electrophoresis. In actuality, however, dielectric electrophoresis is sometimes included. If both electrophoreses are mixed, it is difficult to strictly separate them. In such a case, if a phenomenon similar to that described herein occurs, the case can be considered as one case of the present application.

There is a case where the movement of the dispersion medium 21 resulting from the movement of the particles 26 or 27 sometimes helps the movement of particles, so that the particles move more easily. This case can be considered as another case of the present application.

The entire disclosure of Japanese Patent Application No. 2010-116412, filed May 20, 2010 and No. 2011-056718, filed Mar. 15, 2011 is expressly incorporated by reference herein.

What is claimed is:

1. An electrophoretic display device comprising:
a first substrate and a second substrate;
an electrophoretic layer disposed between the first substrate and the second substrate and containing at least a dispersion medium and positively or negatively charged particles mixed in the dispersion medium;
first electrodes formed in island shapes and driven independently in respective pixels on a side of the electrophoretic layer of the first substrate;
a second electrode formed on a side of the electrophoretic layer of the second substrate and having a larger area than the first electrodes;
transistors connected to the first electrodes; and
a first control electrode disposed in at least part of an area where the first electrodes are absent above a drain electrode of a first transistor of the transistors,
wherein a potential for repelling the particles is applied to the first control electrode.

2. The electrophoretic display device according to claim 1, wherein the potential for repelling the particles is the same potential as a potential of the second electrode, the same potential as a potential of the first electrodes, or a potential between the potential of the first electrodes and the potential of the second electrode.

3. The electrophoretic display device according to claim 1, wherein the first control electrode is disposed between a layer in which the first electrodes are formed and a layer in which the drain electrode of the first transistor is formed.

4. The electrophoretic display device according to claim 1, wherein the first control electrode is formed in the same layer as the layer in which the first electrodes are formed.

5. The electrophoretic display device according to claim 1, wherein the first control electrode is provided with openings at positions facing the first electrodes, the openings having areas larger than areas of the first electrodes.

6. The electrophoretic display device according to claim 5, wherein the openings have shapes similar to shapes in plan view of the first electrodes.

7. The electrophoretic display device according to claim 1, wherein a plurality of the first electrodes are connected to one another with a first connecting electrode formed in a layer closer to the first substrate than the first electrodes.

8. The electrophoretic display device according to claim 1, further comprising:
third electrodes formed in the respective pixels on the side of the electrophoretic layer of the first substrate and driven independently of the first electrodes; and
a second transistor of the transistors, the second transistor being connected to the third electrodes.

9. The electrophoretic display device according to claim 8, wherein a second control electrode is disposed in at least part of an area where the third electrodes are absent above a drain electrode of the second transistor.

10. The electrophoretic display device according to claim 8, wherein
a plurality of the first electrodes are connected to one another with a first connecting electrode formed in a layer closer to the first substrate than the first electrodes, and
a plurality of the third electrodes are connected to one another with a second connecting electrode formed in a layer closer to the first substrate than the third electrodes.

11. The electrophoretic display device according to claim 9, further comprising a first scanning line, a second scanning line, a first data line, and a second data line, wherein
the first transistor connected to the first scanning line and the first data line and the second transistor connected to the second scanning line and the second data line are disposed in each of the pixels,
the first control electrode is formed in a layer different from the drain electrode of the first transistor, and
the second control electrode is formed in a layer different from the drain electrode of the second transistor.

12. The electrophoretic display device according to claim 1, wherein a first particle of the particles and a second particle of the particles are mixed in the dispersion medium, the first particle being positively charged, and the second particle being negatively charged and differing in color from the first particle.

13. A method of driving an electrophoretic display device including a first substrate and a second substrate, an electrophoretic layer disposed between the first substrate and the second substrate and containing at least a dispersion medium and positively or negatively charged particles mixed in the dispersion medium, first electrodes formed in island shapes and driven independently in respective pixels on a side of the electrophoretic layer of the first substrate, a second electrode formed on a side of the electrophoretic layer of the second substrate and having a larger area than the first electrodes, and transistors connected to the first electrodes, wherein a first control electrode is disposed in at least part of an area where the first electrodes are absent above a drain electrode of a first transistor of the transistors, and a gray scale is controlled by using an area of the particles visually recognized when the electrophoretic layer is viewed from a side of the second electrode, the method comprising:
performing a first operation of drawing the particles to a side of the first electrodes for the first electrodes and the second electrode; and
performing a second operation of drawing the particles to the side of the second electrode for the first electrodes and the second electrode,
wherein, in the first operation and the second operation, a potential for repelling the charged particles is applied to the first control electrode.

14. The method according to claim 13, wherein the first control electrode is caused to have the same potential as a potential of the second electrode, the same potential as a potential of the first electrodes, or a potential between the potential of the first electrodes and the potential of the second electrode.

15. The method according to claim 13, wherein a two-dimensional or three-dimensional distribution of the charged particles on the side of the second substrate is controlled by using magnitudes and durations of voltages to be applied to the first electrodes and the second electrode.

16. The method according to claim 15, wherein the durations are controlled by using a pulse width or a number of frames.

17. The method according to claim 13, wherein
the electrophoretic display device includes third electrodes on the side of the electrophoretic layer of the first substrate, and
voltages different from each other are simultaneously applied to the first electrodes and the third electrodes.

18. The method according to claim 13, wherein
the electrophoretic display device includes third electrodes on the side of the electrophoretic layer of the first substrate, and
voltages different from each other are sequentially applied to the first electrodes and the third electrodes.

19. The method according to claim 13, wherein the electrophoretic display device includes third electrodes on the side of the electrophoretic layer of the first substrate, the method further comprising:
performing a first pre-set operation of applying to the first electrodes a voltage of positive polarity with respect to the second electrode and applying to the third electrodes a voltage of negative polarity with respect to the second electrode, thereby drawing the particles to the side of the first electrodes and to a side of the third electrodes; and
performing a second pre-set operation of applying to the first electrodes a voltage of negative polarity with respect to the second electrode and applying to the third electrodes a voltage of positive polarity with respect to the second electrode, thereby drawing the particles to the side of the first electrodes and to the side of the third electrodes.

20. An electronic apparatus comprising the electrophoretic display device according to claim 1.
